(19) United States
(12) Patent Application Publication
(10) Pub. No.: US 2016/0237215 A1
(43) Pub. Date: Aug. 18, 2016

(54) POLYAMIDE COMPOUND

(71) Applicant: Ajinomoto Co., Inc., Tokyo (JP)

(72) Inventors: Ryotaro NAKAYA, Kawasaki-shi (JP); Fumi OGATA, Kawasaki-shi (JP); Takashi INEYAMA, Kawasaki-shi (JP); Keiichi YOKOYAMA, Kawasaki-shi (JP)

(73) Assignee: Ajinomoto Co., Inc., Tokyo (JP)

(21) Appl. No.: 15/135,992

(22) Filed: Apr. 22, 2016

Related U.S. Application Data
(63) Continuation of application No. PCT/JP2014/078141, filed on Oct. 22, 2014.

(30) Foreign Application Priority Data
Oct. 23, 2013 (JP) 2013-220555

(51) Int. Cl. C08G 73/22

(52) U.S. Cl. CPC C08G 73/22

(57) ABSTRACT

Polyamide compounds obtained by reacting a compound represented by formula (1):

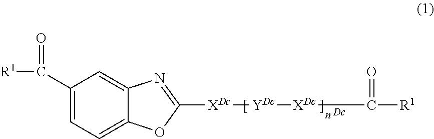

with a compound represented by formula (2):

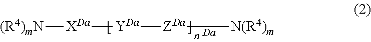

where the variables are described herein exhibit excellent heat resistance.

### CROSS REFERENCES TO RELATED APPLICATIONS

This application is a continuation of International Patent Application No. PCT/JP2014/078141, filed on Oct. 22, 2014, and claims priority to Japanese Patent Application No. 2013-220555, filed on Oct. 23, 2013, both of which are incorporated herein by reference in their entireties.

### BACKGROUND OF THE INVENTION

1. Field of the Invention

The present invention relates to a polyamide compounds.

2. Discussion of the Background

A polyamide compound obtained by a reaction of a dicarboxylic acid such as terephthalic acid with a diamine compound such as 1,6-diaminohexane has a high thermal resistance and excellent strength. Therefore, polyamide compounds have been used as an engineering plastic (see, for example, JP-A-H03-072564 and JP-A-H08-059825, both of which are incorporated herein by reference in their entireties). Such engineering plastics have been used in fields of automobiles, airplanes, electrical and electronic devices, machines, and the like. A range of application thereof has been increased.

Due to an increase in the range of applications of engineering plastics, however, the use environment thereof becomes more severe. For this reason, polyamide compounds having more excellent thermal resistance have been required.

### SUMMARY OF THE INVENTION

Accordingly, it is one object of the present invention to provide novel polyamide compounds having excellent thermal resistance.

This and other objects, which will become apparent during the following detailed description, have been achieved by the inventors' discovery that polyamide compounds obtained by a reaction of a dicarboxylic acid having a specific structure with a diamine having a specific structure has high thermal resistance.

Thus, the present invention provides:

(1) A polyamide compound, which is obtained by reacting:

(1) a compound represented by formula (1):

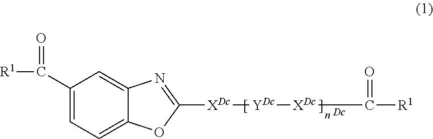

wherein:

R¹ is a hydroxy group, a halogen atom, an alkoxy group, a cycloalkyloxy group, an aryloxy group, —OM, or —O—Si(R²)₃, wherein M is a metal atom, and R² is an alkyl group;

X^{Dc} is a divalent aromatic group optionally having a substituent, a divalent aliphatic hydrocarbon group optionally having a substituent, or a divalent non-aromatic heterocyclic group optionally having a substituent;

Y^{Dc} is —O—, —N═N—, a carbonyl group, an alkenylene group optionally having a substituent, or a single bond; and

n^{Dc} is an integer of 0 to 2;

wherein:

the two R¹ groups may be the same or different from each other;

when there are a plurality of X^{Dc} groups, they may be the same or different from each other; and

when there are a plurality of Y^{Dc} groups, they may be the same or different from each other,

with a compound represented by formula (2):

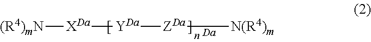

wherein:

m is 1 or 2;

when m is 1, R⁴ is ═C═O, and when m is 2, R⁴ is a hydrogen atom, an acyl group, or —Si(R⁵)₃, wherein R⁵ is an alkyl group;

X^{Da} represents a divalent aliphatic hydrocarbon group optionally having a substituent;

Y^{Da} is an imino group optionally having a substituent, a divalent aromatic group optionally having a substituent, a divalent non-aromatic heterocyclic group optionally having a substituent, an oxyalkylene group optionally having a substituent, —S—, an alkylene group optionally having a substituent, or a cycloalkylene group optionally having a substituent;

Z^{Da} is a divalent aliphatic hydrocarbon group optionally having a substituent or a single bond; and

n^{Da} is an integer of 0 to 5;

wherein:

each of the plurality of R⁴ groups may be the same or different from each other;

when there are a plurality of Y^{Da} groups, they may be the same or different from each other; and

when there are a plurality of Z^{Da} groups, they may be the same or different from each other.

(2) The polyamide compound according to (1), wherein X^{Dc} is a phenylene group optionally having a substituent, a naphthylene group optionally having a substituent, an anthracenylene group optionally having a substituent, a frandiyl group optionally having a substituent, a pyridinediyl group optionally having a substituent, a thiophenediyl group optionally having a substituent, a quinolinediyl group optionally having a substituent, an alkylene group optionally having a substituent, a cycloalkylene group optionally having a substituent, an alkenylene group optionally having a substituent, a cycloalkenylene group optionally having a substituent, an alkynylene group optionally having a substituent, or a divalent non-aromatic heterocyclic group having an oxygen atom as a heteroatom constituting the heterocyclic ring and optionally having a substituent.

(3) The polyamide compound according to (1) or (2), wherein X^{Da} is an alkylene group optionally having a substituent or a cycloalkylene group optionally having a substituent.

(4) The polyamide compound according to any one of (1) to (3), wherein Z^{Da} is an alkylene group optionally having a substituent, a cycloalkylene group optionally having a substituent, or a single bond.

(5) The polyamide compound according to any one of (1) to (4), wherein n^{Dc} is 0, and X^{Dc} is a phenylene group optionally having a substituent.

(6) The polyamide compound according to any one of (1) to (5), wherein:

i) n^{Da} is 0, and X^{Da} is an alkylene group having 1 to 15 carbon atoms, and optionally having a substituent, or a cycloalkylene group having 3 to 10 carbon atoms and optionally having a substituent; or

ii) n^{Da} is 1 or 2, X^{Da} is an alkylene group, having 1 to 6 carbon atoms, and optionally having a substituent, or a cycloalkylene group, having 3 to 10 carbon atoms, and optionally having a substituent, Y^{Da} is an imino group optionally having a substituent, an oxyalkylene group, having 1 to 6 carbon atoms, and optionally having a substituent, a divalent non-aromatic heterocyclic group, having a nitrogen atom as a heteroatom constituting the heterocyclic ring and 2 to 5 carbon atoms, and optionally having a substituent, or a phenylene group optionally having a substituent, and Z^{Da} is an alkylene group, having 1 to 3 carbon atoms, and optionally having a substituent, a cycloalkylene group, having 3 to 10 carbon atoms, and optionally having a substituent, or a single bond.

(7) The polyamide compound according to any one of (1) to (6), wherein said substituent is selected from the group consisting of a halogen atom, an alkyl group, an aryl group, an alkylidene group, a hydroxy group, an amino group, and an oxo group.

(8) The polyamide compound according to any one of (1) to (5), wherein said compound represented by formula (2) is one or more compounds represented by formulae (2-1) to (2-36):

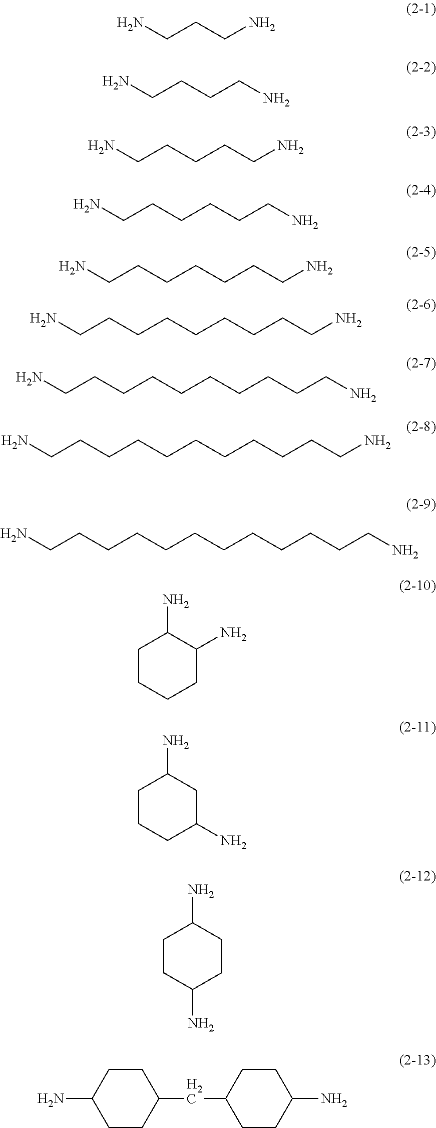

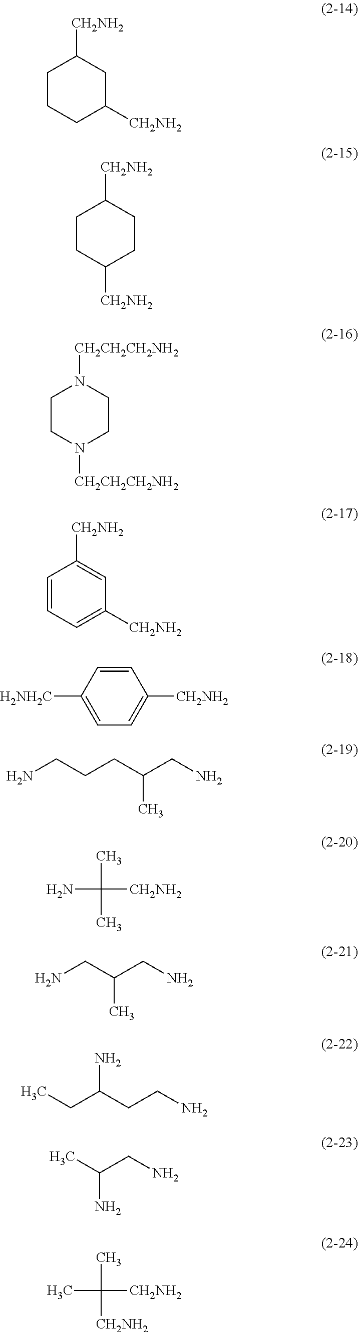

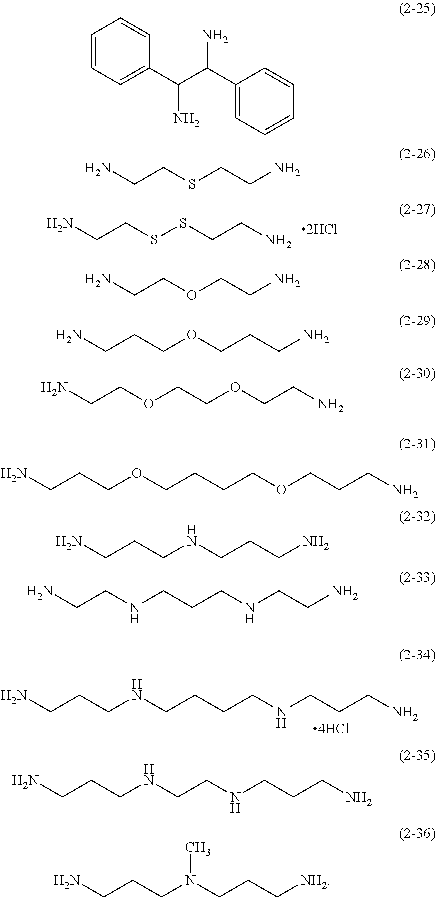

(9) The polyamide compound according to (8), wherein said compound represented by formula (2) is a compound represented by formula (2-3), (2-4), (2-6), (2-13), (2-16), (2-18), (2-23), (2-28), or (2-32).

(10) The polyamide compound according to any one of (1) to (9), which is obtained by a reaction of a compound represented by formula (1), a compound represented by formula (2), and one or more members selected from the group consisting of an aromatic dicarboxylic acid, a salt thereof, an ester thereof, and a halide thereof.

(11) The polyamide compound according to any one of (1) to (10), which is obtained by a reacting said compound represented by formula (1) with said compound represented by formula (2) in a molar ratio (the compound represented by the formula (1))/(the compound represented by the formula (2)) of 10/1 to 1/10.

(12) The polyamide compound according to any one of (1) to (11), wherein said reacting is conducted at a temperature of −10° C. to 200° C.

(13) A polyamide compound, containing one or more structural units represented by formulae (i) to (iv):

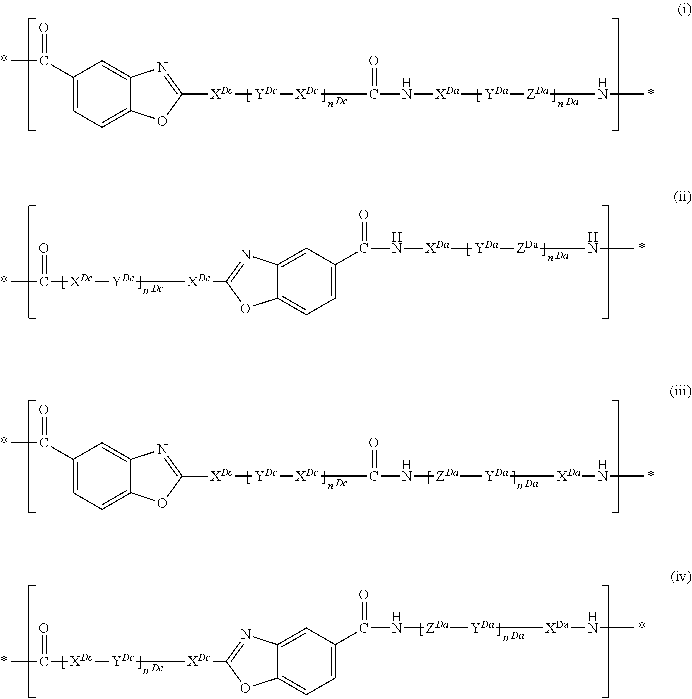

wherein:

X^{Dc} is a divalent aromatic group optionally having a substituent, a divalent aliphatic hydrocarbon group optionally having a substituent, or a divalent non-aromatic heterocyclic group optionally having a substituent;

Y^{Dc} is —O—, —N═N—, a carbonyl group, an alkenylene group optionally having a substituent, or a single bond;

n^{Dc} is an integer of 0 to 2;

X^{Da} is a divalent aliphatic hydrocarbon group optionally having a substituent;

Y^{Da} is an imino group optionally having a substituent, a divalent aromatic group optionally having a substituent, a divalent non-aromatic heterocyclic group optionally having a substituent, an oxyalkylene group optionally having a substituent, —S—, an alkylene group optionally having a substituent, or a cycloalkylene group optionally having a substituent;

Z^{Da} is a divalent aliphatic hydrocarbon group optionally having a substituent or a single bond; and

n^{Da} is an integer of 0 to 5; and

* represents the connection point to the rest of the compound;

wherein:

when there are a plurality of X^{Dc} groups, they may be the same or different from each other;

when there are a plurality of Y^{Dc} groups, they may be the same or different from each other;

when there are a plurality of Y^{Da} groups, they may be the same or different from each other; and

when there are a plurality of Z^{Da} groups, they may be the same as or different from each other.

(14) The polyamide compound according to (13), which exhibits a middle glass transition point (T_{mg}) of 100° C. or higher and 400° C. or lower.

(15) The polyamide compound according to (13) or (14), which exhibits a melting point (Tₘ) of 230° C. or higher and 500° C. or lower.

(16) The polyamide compound according to any one of (13) to (15), which exhibits a 5% mass decrease temperature (T_{d}) of 250° C. or higher and 500° C. or lower.

(17) A method of producing a polyamide compound, comprising reacting

(1) a compound represented by formula (1):

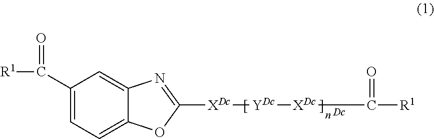

wherein:

R¹ is a hydroxy group, a halogen atom, an alkoxy group, a cycloalkyloxy group, an aryloxy group, —OM, or —O—Si(R²)₃, wherein M is a metal atom, and R² is an alkyl group;

X^{Dc} is a divalent aromatic group optionally having a substituent, a divalent aliphatic hydrocarbon group optionally having a substituent, or a divalent non-aromatic heterocyclic group optionally having a substituent;

Y^{Dc} is —O—, —N═N—, a carbonyl group, an alkenylene group optionally having a substituent, or a single bond; and

n^{Dc} is an integer of 0 to 2;

wherein:

the two R¹ groups may be the same or different from each other;

when there are a plurality of X^{Dc} groups, they may be the same or different from each other; and

when there are a plurality of Y^{Dc} groups, they may be the same or different from each other, with

(2) a compound represented by formula (2):

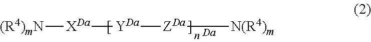

wherein:

m is 1 or 2;

when m is 1, R⁴ is ═C═O, and when m is 2, R⁴ is a hydrogen atom, an acyl group, or —Si(R⁵)₃, wherein R⁵ is an alkyl group;

X^{Da} is a divalent aliphatic hydrocarbon group optionally having a substituent;

Y^{Da} is an imino group optionally having a substituent, a divalent aromatic group optionally having a substituent, a divalent non-aromatic heterocyclic group optionally having a substituent, an oxyalkylene group optionally having a substituent, —S—, an alkylene group optionally having a substituent, or a cycloalkylene group optionally having a substituent;

Z^{Da} is a divalent aliphatic hydrocarbon group optionally having a substituent or a single bond; and

n^{Da} is an integer of 0 to 5;

wherein:

each of the plurality of R⁴ groups may be the same or different from each other;

when there are a plurality of Y^{Da} groups, they may be the same or different from each other; and

when there are a plurality of Z^{Da} groups, they may be the same as or different from each other,

at a molar ratio of (the compound represented by formula (1))/(the compound represented by formula (2)) of 10/1 to 1/10.

The present invention provides novel polyamide compounds having excellent thermal resistance.

### DETAILED DESCRIPTION OF THE PREFERRED EMBODIMENTS

### Explanation of Terminology

In the present description, a “divalent aromatic group” herein refers to a group derived from an aromatic compound by removal of two hydrogen atoms from an aromatic ring, and includes an arylene group and a heteroarylene group. The heteroarylene group refers to a group derived from an aromatic heterocyclic compound by removal of two hydrogen atoms from a heterocyclic ring. The heterocyclic ring means a ring containing a carbon atom and a heteroatom such as an oxygen atom, a sulfur atom, a nitrogen atom, a phosphorus atom, a boron atom, and a silicon atom as atoms constituting the ring.

In the present description, a “divalent non-aromatic heterocyclic group” herein refers to a group derived from a non-aromatic heterocyclic compound by removal of two hydrogen atoms from a heterocyclic ring.

In the present description, the term “Cₚ to C_{q}” (wherein p and q are positive integers and satisfy p<q) herein represents that the number of the carbon atoms in an organic group described immediately after the term is p to q. For example, a “C₁ to C₁₂ alkyl group” is an alkyl group having 1 to 12 carbon atoms, and a “C₁ to C₁₂ alkyl ester” is an ester having an alkyl group having 1 to 12 carbon atoms.

In the present description, the phrase “optionally having a substituent” that is described immediately before a compound or a group herein includes the case where none of the hydrogen atoms of the compound or the group is substituted by the substituent and the case where a part or all of hydrogen atoms of the compound or the group is substituted by the substituent.

In the present description, the term “substituent” herein represents a halogen atom, an alkyl group, a cycloalkyl group, an alkoxy group, a cycloalkyloxy group, an aryl group, an aryloxy group, an arylalkyl group, an arylalkoxy group, a monovalent heterocyclic group, an alkylidene group, an amino group, a silyl group, an acyl group, an acyloxy group, a carboxy group, a cyano group, a nitro group, a hydroxy group, a mercapto group, or an oxo group, unless otherwise noted.

Examples of a halogen atom used as the substituent may include a fluorine atom, a chlorine atom, a bromine atom, and an iodine atom.

An alkyl group used as the substituent may be linear or branched. The number of carbon atoms in the alkyl group is preferably 1 to 20, more preferably 1 to 14, further preferably 1 to 12, still more preferably 1 to 6, and particularly preferably 1 to 3. Examples of the alkyl group may include a methyl group, an ethyl group, a propyl group, an isopropyl group, a butyl group, a sec-butyl group, an isobutyl group, a tert-butyl group, a pentyl group, a hexyl group, a heptyl group, an octyl group, a nonyl group, and a decyl group. The alkyl group used as the substituent may further have another substituent (additional substituent), as described below. Examples of an alkyl group having the additional substituent may include an alkyl group substituted by a halogen atom, Specifically examples thereof may include a trifluoromethyl group, a trichloromethyl group, a tetrafluoroethyl group, and a tetrachloroethyl group.

The number of carbon atoms in a cycloalkyl group used as the substituent is preferably 3 to 20, more preferably 3 to 12, and further preferably 3 to 6. Examples of the cycloalkyl group may include a cyclopropyl group, a cyclobutyl group, a cyclopentyl group, and a cyclohexyl group.

An alkoxy group used as the substituent may be linear or branched. The number of carbon atoms in the alkoxy group is preferably 1 to 20, more preferably 1 to 12, and further preferably 1 to 6. Examples of the alkoxy group may include a methoxy group, an ethoxy group, a propyloxy group, an isopropyloxy group, a butoxy group, a sec-butoxy group, an isobutoxy group, a tert-butoxy group, a pentyloxy group, a hexyloxy group, a heptyloxy group, an octyloxy group, a nonyloxy group, and a decyloxy group.

The number of carbon atoms in a cycloalkyloxy group used as the substituent is preferably 3 to 20, more preferably 3 to 12, and further preferably 3 to 6. Examples of the cycloalkyloxy group may include a cyclopropyloxy group, a cyclobutyloxy group, a cyclopentyloxy group, and a cyclohexyloxy group.

An aryl group used as the substituent is a group derived from an aromatic hydrocarbon by removal of one hydrogen atom on an aromatic ring. The number of carbon atoms in the aryl group used as the substituent is preferably 6 to 24, more preferably 6 to 18, further preferably 6 to 14, and still more preferably 6 to 10. Examples of the aryl group may include a phenyl group, a naphthyl group, and an anthracenyl group.

The number of carbon atoms in an aryloxy group used as the substituent is preferably 6 to 24, more preferably 6 to 18, further preferably 6 to 14, and still more preferably 6 to 10. Examples of the aryloxy group used as the substituent may include a phenoxy group, a 1-naphthyloxy group, and a 2-naphthyloxy group.

The number of carbon atoms in an arylalkyl group used as the substituent is preferably 7 to 25, more preferably 7 to 19, further preferably 7 to 15, and still more preferably 7 to 11. Examples of the arylalkyl group may include a phenyl-C₁ to C₁₂ alkyl group, a naphthyl-C₁ to C₁₂ alkyl group, and an anthracenyl-C₁ to C₁₂ alkyl group.

The number of carbon atoms in an arylalkoxy group used as the substituent is preferably 7 to 25, more preferably 7 to 19, further preferably 7 to 15, and still more preferably 7 to 11. Examples of the arylalkoxy group may include a phenyl-C₁ to C₁₂ alkoxy group and a naphthyl-C₁ to C₁₂ alkoxy group.

A monovalent heterocyclic group used as the substituent refers to a group derived from a heterocyclic compound by removal of a hydrogen atom from a heterocyclic ring. The number of carbon atoms in the monovalent heterocyclic group is preferably 3 to 21, more preferably 3 to 15, and further preferably 3 to 9. The monovalent heterocyclic group also includes a monovalent aromatic heterocyclic group (heteroaryl group). Examples of the monovalent heterocyclic ring group may include a thienyl group, a pyrrolyl group, a furyl group, a pyridyl group, a pyridazinyl group, a pyrimidyl group, a pyrazinyl group, a triazinyl group, a pyrrolidyl group, a piperidyl group, a quinolyl group, and an isoquinolyl group.

An alkylidene group used as the substituent refers to a group derived from an alkane by removal of two hydrogen atoms from the same carbon atom. The number of carbon atoms in the alkylidene group is preferably 1 to 20, more preferably 1 to 14, further preferably 1 to 12, still more preferably 1 to 6, and particularly preferably 1 to 3. Examples of the alkylidene group may include a methylidene group, an ethylidene group, a propylidene group, an isopropylidene group, a butylidene group, a sec-butylidene group, an isobutylidene group, a tert-butylidene group, a pentylidene group, a hexylidene group, a heptylidene group, an octylidene group, a nonylidene group, and a decylidene group.

An acyl group used as the substituent refers to a group represented by formula: —C(═O)—R (wherein R is an alkyl group or an aryl group). The alkyl group represented by R may be linear or branched. Examples of the aryl group represented by R may include a phenyl group, a naphthyl group, and an anthracenyl group. The number of carbon atoms in the acyl group is preferably 2 to 20, more preferably 2 to 13, and further preferably 2 to 7. Examples of the acyl group may include an acetyl group, a propionyl group, a butyryl group, an isobutyryl group, a pivaloyl group, and a benzoyl group.

An acyloxy group used as the substituent refers to a group represented by formula: —O—C(═O)—R (wherein R is an alkyl group or an aryl group). The alkyl group represented by R may be linear or branched. Examples of the aryl group represented by R may include a phenyl group, a naphthyl group, and an anthracenyl group. The number of carbon atoms in the acyloxy group is preferably 2 to 20, more preferably 2 to 13, and further preferably 2 to 7. Examples of the acyloxy group may include an acetoxy group, a propionyloxy group, a butyryloxy group, an isobutyryloxy group, a pivaloyloxy group, and a benzoyloxy group.

The substituent may further have the other substituent (hereinafter sometimes referred to as “additional substituent”). Unless otherwise noted, the same substituent as described above may be used as the additional substituent.

Hereinafter, the present invention will be described in detail according to preferred embodiments.

### Polyamide Compound.

A polyamide compound of the present invention is obtained by a reaction of a compound represented by the following formula (1):

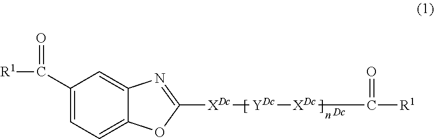

wherein:

R¹ represents a hydroxy group, a halogen atom, an alkoxy group, a cycloalkyloxy group, an aryloxy group, a group represented by formula: —OM, or a group represented by formula: —O—Si(R²)₃, wherein M is a metal atom, and R² is an alkyl group;

X^{Dc} represents a divalent aromatic group optionally having a substituent, a divalent aliphatic hydrocarbon group optionally having a substituent, or a divalent non-aromatic heterocyclic group optionally having a substituent;

Y^{Dc} represents a group represented by formula: —O—, a group represented by formula: —N═N—, a carbonyl group, an alkenylene group optionally having a substituent, or a single bond; and

n^{Dc} represents an integer of 0 to 2; the two R¹s may be the same as or different from each other; when there are a plurality of X^{Dc}, they may be the same as or different from each other; and when there are a plurality of Y^{Dc}, they may be the same as or different from each other,

with a compound represented by the following formula (2):

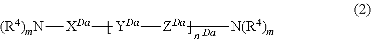

wherein:

m is 1 or 2;

when m is 1, R⁴ represents a group represented by formula: ═C═O, and when m is 2, R⁴ represents a hydrogen atom, a group represented by formula: —Si(R⁵)₃, or an acyl group, wherein R⁵ is an alkyl group;

X^{Da} A represents a divalent aliphatic hydrocarbon group optionally having a substituent;

Y^{Da} represents an imino group optionally having a substituent, a divalent aromatic group optionally having a substituent, a divalent non-aromatic heterocyclic group optionally having a substituent, an oxyalkylene group optionally having a substituent, a group represented by formula: —S—, an alkylene group optionally having a substituent, or a cycloalkylene group optionally having a substituent;

Z^{Da} represents a divalent aliphatic hydrocarbon group optionally having a substituent or a single bond; and

n^{Da} represents an integer of 0 to 5; the plurality of R⁴ may be the same as or different from each other; when there are a plurality of Y^{Da}, they may be the same as or different from each other; and when there are a plurality of Z^{Da}, they may be the same as or different from each other.

In the formula (1), R¹ represents a hydroxy group, a halogen atom, an alkoxy group, a cycloalkyloxy group, an aryloxy group, a group represented by formula: —OM, or a group represented by formula: —O—Si(R²)₃. Herein, M is a metal atom. R² is an alkyl group. The two R¹ may be the same as or different from each other.

Examples of the halogen atom represented by R¹ may include a fluorine atom, a chlorine atom, a bromine atom, and an iodine atom. A chlorine atom is preferable.

The alkoxy group represented by R¹ may be linear or branched. The number of carbon atoms in the alkoxy group is preferably 1 to 10, more preferably 1 to 6, and further preferably 1 to 4. Examples of the alkoxy group represented by R¹ may include a methoxy group, an ethoxy group, a propoxy group, an isopropyloxy group, a butoxy group, a sec-butyloxy group, an isobutyloxy group, a tert-butyloxy group, a pentyloxy group, a hexyloxy group, a heptyloxy group, an octyloxy group, a nonyloxy group, and a decyl group.

The number of carbon atoms in the cycloalkyloxy group represented by R¹ is preferably 3 to 10, and more preferably from 3 to 6. Examples of the cycloalkyloxy group represented by R¹ may include a cyclopropyloxy group, a cyclobutyloxy group, a cyclopentyloxy group, and a cyclohexyloxy group.

The number of carbon atoms in the aryloxy group represented by R¹ is preferably 6 to 18, more preferably 6 to 14, and further preferably 6 to 10. Examples of the aryloxy group may include a phenyloxy group, a naphthyloxy group, and an anthracenyloxy group.

When R¹ is a group represented by formula: —OM (wherein M is a metal atom), examples of the metal atom represented by M may include an alkali metal. A lithium atom, a sodium atom, a potassium atom, and a cesium atom are preferable, and a potassium atom is more preferable.

When R¹ is a group represented by formula: —O—Si(R²)₃ (wherein R² is an alkyl group), the alkyl group represented by R² may be linear or branched. The number of carbon atoms in the alkyl group represented by R² is preferably 1 to 10, more preferably 1 to 6, further preferably 1 to 4, still more preferably 1 to 3, and particularly preferably 1 or 2. In the group represented by formula: —O—Si(R²)₃, the three R² may be the same as or different from each other. Specific examples of the group represented by formula: —O—Si(R²)₃ may include a trimethylsilyloxy group.

It is preferable that R¹ be a hydroxy group, a halogen atom, or an alkoxy group, more preferably a hydroxy group or a halogen atom, and further preferably a hydroxy group.

In the formula (1), X^{Dc} represents a divalent aromatic group optionally having a substituent, a divalent aliphatic hydrocarbon group optionally having a substituent, or a divalent non-aromatic heterocyclic group optionally having a substituent.

Examples of the divalent aromatic group in X^{Dc} may include an arylene group and a hetroarylene group. An arylene group having 6 to 24 carbon atoms and a heteroarylene group having 3 to 21 carbon atoms are preferable, an arylene group having 6 to 18 carbon atoms and a heteroarylene group having 3 to 15 carbon atoms are more preferable, an arylene group having 6 to 14 carbon atoms and a heteroarylene group having 3 to 9 carbon atoms are further preferable, and an arylene group having 6 to 10 carbon atoms and a heteroarylene group having 3 to 6 carbon atoms are still more preferable. The above-described number of carbon atoms does not include the number of carbon atoms in the substituent.

Specific examples of the divalent aromatic group in X^{Dc} may include a phenylene group, a naphthylene group, an anthracenylene group, a pyrenediyl group, a pyrrolediyl group, a furandiyl group, a thiophenediyl group, a pyridinediyl group, a pyridazinediyl group, a pyrimidinediyl group, a pyrazinediyl group, a triazinediyl group, a pyrrolinediyl group, a piperidinediyl group, a triazolediyl group, a purinediyl group, an anthraquinonediyl group, a carbazolediyl group, a fluorenediyl group, a quinolinediyl group, and an isoquinolinediyl group.

From the viewpoint of obtaining a polyamide compound having excellent thermal resistance, it is preferable that the divalent aromatic group in X^{Dc} be an arylene group having 6 to 14 carbon atoms or a heteroarylene group having 3 to 9 carbon atoms, more preferably a phenylene group, a naphthylene group, an anthracenylene group, a furandiyl group, a pyridinediyl group, a thiophenediyl group, or a quinolinediyl group, and further preferably a phenylene group or a naphthylene group.

The divalent aliphatic hydrocarbon group in X^{Dc} may be a saturated hydrocarbon group or an unsaturated hydrocarbon group. The number of carbon atoms in the group is preferably 1 to 60, more preferably 1 to 40, further preferably 1 to 30, still more preferably 1 to 20, and particularly preferably 1 to 10 or 1 to 6. The above-described number of carbon atoms does not include the number of carbon atoms in the substituent.

Examples of the divalent aliphatic hydrocarbon group in X^{Dc} may include an alkylene group, a cycloalkylene group, an alkenylene group, a cycloalkenylene group, an alkynylene group, a cycloalkynylene group, an alkapolyenylene group (the number of double bonds is preferably 2 to 10, more preferably 2 to 6, further preferably 2 to 4, and still more preferably 2), an alkadiynylene group, and an alkatriynylene group. An alkylene group, a cycloalkylene group, an alkenylene group, a cycloalkenylene group, and an alkynylene group are preferable, an alkylene group and a cycloalkylene group are more preferable, and a cycloalkylene group is further preferable.

The number of carbon atoms in the alkylene group in X^{Dc} is preferably 1 to 60, more preferably 1 to 40, further preferably 1 to 30, still more preferably 1 to 20, and particularly preferably 1 to 15, 1 to 12, 1 to 9, 1 to 6, or 1 to 4. The above-described number of carbon atoms does not include the number of carbon atoms in the substituent. Examples of the alkylene group may include a methylene group, an ethylene group, a propylene group, a butylene group, a pentylene group, a hexylene group, a heptylene group, an octylene group, a nonylene group, a decylene group, an undecylene group, a dodecylene group, a tridecylene group, a tetradecylene group, a pentadecylene group, a hexadecylene group, a heptadecylene group, an octadecylene group, a nonadecylene group, and an icosylene group.

The number of carbon atoms in the cycloalkylene group in X^{Dc} is preferably 3 to 10, and more preferably 3 to 6. The above-described number of carbon atoms does not include the number of carbon atoms in the substituent. Examples of the cycloalkylene group may include a cyclopropylene group, a cyclobutylene group, a cyclopentylene group, a cyclohexylene group, a decahydronaphthanylene group, a norbornanylene group, and an adamantanylene group.

The number of carbon atoms in the alkenylene group in X^{Dc} is preferably 2 to 60, more preferably 2 to 40, further preferably 2 to 30, still more preferably 2 to 20, and particularly preferably 2 to 10, 2 to 6, or 2 or 3. The above-described number of carbon atoms does not include the number of carbon atoms in the substituent. Examples of the alkenylene group may include an ethenylene group, a propenylene group, a butenylene group, a pentenylene group, a hexenylene group, a heptenylene group, an octenylene group, a nonenylene group, a decenylene group, a undecenylene group, a dodecenylene group, a tridecenylene group, a tetradecenylene group, a pentadecenylene group, a hexadecenylene group, a heptadecenylene group, an octadecenylene group, a nonadecenylene group, and an icosenylene group.

The number of carbon atoms in the cycloalkenylene group in X^{Dc} is preferably 3 to 10, and more preferably 3 to 6. The above-described number of carbon atoms does not include the number of carbon atoms in the substituent. Examples of the cycloalkenylene group may include a cyclopropenylene group, a cyclobutenylene group, a cyclopentenylene group, a cyclohexenylene group, and a norbornenylene group.

The number of carbon atoms in the alkynylene group in X^{Dc} is preferably 2 to 60, more preferably 2 to 40, further preferably 2 to 30, still more preferably 2 to 20, and particularly preferably 2 to 10, 2 to 6, or 2 or 3. The above-described number of carbon atoms does not include the number of carbon atoms in the substituent. Examples of the alkynylene group may include an ethynylene group, a propynylene group, a butynylene group, a pentynylene group, a hexynylene group, a heptynylene group, and an octynylene group.

The number of carbon atoms in the divalent non-aromatic heterocyclic group in X^{Dc} is preferably 2 to 21, more preferably 2 to 15, further preferably 2 to 9, still more preferably 2 to 6, and particularly preferably 2 to 5. The above-described number of carbon atoms does not include the number of carbon atoms in the substituent. It is preferable that the divalent non-aromatic heterocyclic group in X^{Dc} contain, as a heteroatom constituting the heterocyclic ring, one or more selected from the group consisting of an oxygen atom, a sulfur atom, a nitrogen atom, a phosphorus atom, a boron atom, and a silicon atom, and more preferably one or more selected from the group consisting of an oxygen atom, a sulfur atom, and a nitrogen atom.

Specific examples of the divalent non-aromatic heterocyclic group in X^{Dc} may include an oxiranediyl group, an aziridinediyl group, an azetidinediyl group, an oxetanediyl group, a thietanediyl group, a pyrrolidinediyl group, a dihydrofurandiyl group, a tetrahydrofurandiyl group, a dioxolanediyl group, a tetrahydrothiophenediyl group, an imidazolidinediyl group, an oxazolidinediyl group, a piperidinediyl group, a dihydropyrandiyl group, a tetrahydropyrandiyl group, a tetrahydrothiopyrandiyl group, a morpholinediyl group, a thiomorpholinediyl group, a piperazinediyl group, a dihydrooxazinediyl group, a tetrahydrooxazinediyl group, a dihydropyrimidinediyl group, a tetrahydropyrimidinediyl group, and an exo-3,6-epoxy-1,2,3,6-tetrahydrophenylene group. From the viewpoint of obtaining the polyamide compound having excellent heat resistance, it is particularly preferable that the divalent non-aromatic heterocyclic group in) X^{Dc} be a divalent non-aromatic heterocyclic group containing an oxygen atom as a heteroatom constituting the heterocyclic ring, more preferably an oxiranediyl group, an oxetanediyl group, a dihydrofurandiyl group, a tetrahydrofurandiyl group, a dioxolanediyl group, an oxazolidinediyl group, a dihydropyrandiyl group, a tetrahydropyrandiyl group, a morpholinediyl group, a dihydrooxazinediyl group, a tetrahydrooxazinediyl group, or an exo-3,6-epoxy-1,2,3,6-tetrahydrophenylene group, and further preferably an oxiranediyl group, a dioxolanediyl group, a tetrahydropyrandiyl group, or an exo-3,6-epoxy-1,2,3,6-tetrahydrophenylene group.

The substituent that may be contained in the divalent group in X^{Dc} is as described above. When the divalent group in X^{Dc} has a plurality of substituents, they may be the same as or different from each other. In particular, it is preferable that the substituent that may be contained in the divalent group in X^{Dc} be one or more selected from the group consisting of a halogen atom, an alkyl group, an aryl group, an alkylidene group, a hydroxy group, an amino group, and an oxo group, and more preferably one or more selected from the group consisting of a halogen atom, an alkyl group, an aryl group, a hydroxy group, and an amino group. When the substituent is a halogen atom, a chlorine atom, a fluorine atom, and a bromine atom are preferable. When the substituent is an alkyl group, a C₁ to C₆ alkyl group, for example, a methyl group, an ethyl group, a propyl group, an isopropyl group, a butyl group, a sec-butyl group, an isobutyl group, a tert-butyl group, a pentyl group, and a hexyl group are preferable. When the substituent is an alkoxy group, a C₁ to C₆ alkoxy group, for example, a methoxy group, an ethoxy group, a propoxy group, an isopropoxy group, a butoxy group, a sec-butoxy group, an isobutoxy group, a tert-butoxy group, a pentyloxy group, and a hexyloxy group are preferable. When the substituent is an aryl group, a phenyl group is preferable. When the substituent is an alkylidene group, a C₁ to C₆ alkylidene group, for example, a methylidene group, an ethylidene group, a propylidene group, a butylidene group, a pentylidene group, and a hexylidene group are preferable. These substituents may further have the additional substituent. Therefore, the substituent of the present application may include a fluoroalkyl group such as a trifluoromethyl group.

In one preferred embodiment, X^{Dc} is a phenylene group optionally having a substituent, a naphthylene group optionally having a substituent, an anthracenylene group optionally having a substituent, a frandiyl group optionally having a substituent, a pyridinediyl group optionally having a substituent, a thiophenediyl group optionally having a substituent, a quinolinediyl group optionally having a substituent, an alkylene group optionally having a substituent, a cycloalkylene group optionally having a substituent, an alkenylene group optionally having a substituent, a cycloalkenylene group optionally having a substituent, an alkynylene group optionally having a substituent, or a divalent non-aromatic heterocyclic group having an oxygen atom as a heteroatom constituting the heterocyclic ring and optionally having a substituent.

In one more preferred embodiment, X^{Dc} is a phenylene group optionally having a substituent, a naphthylene group optionally having a substituent, or a cycloalkylene group optionally having a substituent.

In the formula (1), Y^{Dc} is a group represented by formula: —O—, a group represented by formula: —N═N—, a carbonyl group, an alkenylene group optionally having a substituent, or a single bond.

The number of carbon atoms in the alkenylene group in Y^{Dc} is preferably 2 to 10, more preferably 2 to 6, further preferably 2 or 3, and still more preferably 2. The above-described number of carbon atoms does not include the number of carbon atoms in the substituent. Examples of the alkenylene group may include an ethenylene group, a propenylene group, a butenylene group, a pentenylene group, a hexenylene group, a heptenylene group, an octenylene group, a nonenylene group, and a decenylene group.

The substituent that may be contained in the alkenylene group in X^{Dc} is as described above. When the alkenylene group in Y^{Dc} has a plurality of substituents, the substituents may be the same or different. In particular, it is preferable that the substituent that may be contained in the alkenylene group in Y^{Dc} be one or more selected from the group consisting of a halogen atom, an alkyl group, an aryl group, an alkylidene group, a hydroxy group, an amino group, and an oxo group, and more preferably one or more selected from the group consisting of a halogen atom, an alkyl group, an aryl group, a hydroxy group, and an amino group. When the substituent is a halogen atom, a chlorine atom, a fluorine atom, and a bromine atom are preferable. When the substituent is an alkyl group, a C₁ to C₆ alkyl group, for example, a methyl group, an ethyl group, a propyl group, an isopropyl group, a butyl group, a sec-butyl group, an isobutyl group, a tert-butyl group, a pentyl group, and a hexyl group are preferable. When the substituent is an aryl group, a phenyl group is preferable. When the substituent is an alkylidene group, a C₁ to C₆ alkylidene group, for example, a methylidene group, an ethylidene group, a propylidene group, a butylidene group, a pentylidene group, and a hexylidene group are preferable. These substituents may further have the additional substituent. Therefore, the substituent of the present application may include a fluoroalkyl group such as a trifluoromethyl group.

In the formula (1), n^{Dc} is an integer of 0 to 2, preferably 0 or 1, and more preferably 0. When there are a plurality of X^{Dc}, they may be the same as or different from each other. When there are a plurality of Y^{Dc}, they may be the same as or different from each other.

In the formula (1), when n^{Dc} is 0, it is preferable that X^{Dc} be a phenylene group optionally having a substituent, a naphthylene group optionally having a substituent, an anthracenylene group optionally having a substituent, a frandiyl group optionally having a substituent, a pyridinediyl group optionally having a substituent, a thiophenediyl group optionally having a substituent, an alkylene group optionally having a substituent, a cycloalkylene group optionally having a substituent, an alkenylene group optionally having a substituent, a cycloalkenylene group optionally having a substituent, an alkynylene group optionally having a substituent, or a divalent non-aromatic heterocyclic group having an oxygen atom as a heteroatom constituting the heterocyclic ring and optionally having a substituent, and more preferably a phenylene group optionally having a substituent, a naphthylene group optionally having a substituent, or a cycloalkylene group optionally having a substituent.

In the formula (1), when n^{Dc} is 1 or 2, it is preferable that X^{Dc} be a phenylene group optionally having a substituent, a pyridinediyl group optionally having a substituent, or a quinolinediyl group optionally having a substituent, and Y^{Dc} be a group represented by formula: —O—, a group represented by formula: —N═N—, a carbonyl group, an alkenylene group optionally having a substituent, or a single bond.

In one preferred embodiment, n^{Dc} is 0 and X^{Dc} is a phenylene group optionally having a substituent in the formula (1).

In one more preferred embodiment, in the formula (1), n^{Dc} is 0 and X^{DC} is a phenylene group optionally having one or more substituents selected from the group consisting of a halogen atom, an alkyl group, an aryl group, a hydroxy group, and an amino group.

In the formula (1), examples of preferable combinations of X^{Dc}, X^{Dc}, and n^{Dc} may include the combinations (1) to (57) shown in Tables 1-1 to 1-7 below. In the Tables, * indicates the connection point to the rest of the compound. In the combinations (1) to (57) described below, a divalent group represented by X^{Dc} has a substituent at a specific position, but the position of the substituent is not particularly limited. A group in which the position of the substituent is different can be suitably used as X^{Dc}. When cis- and trans-isomers are present according to the positional relationship between two coupling hands like X^{DC} shown in the combination (47), the isomers can be suitably used.

TABLE 1-1

| | X^{Dc} | Y^{Dc} | n^{Dc} |
|---|---|---|---|
| (1) | 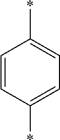 [SMILES: *c1ccc(*)cc1] | — | 0 |
| (2) | 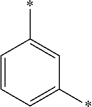 [SMILES: *c1cccc(*)c1] | — | 0 |
| (3) | 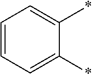 [SMILES: *c1ccccc1*] | — | 0 |
| (4) | 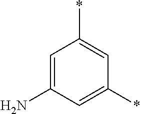 [SMILES: *c1cc(*)cc(N)c1] | — | 0 |
| (5) | 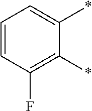 [SMILES: *c1cccc(F)c1*] | — | 0 |
| (6) | 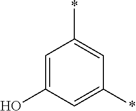 [SMILES: *c1cc(*)cc(O)c1] | — | 0 |
| (7) | 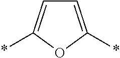 [SMILES: *c1ccc(*)o1] | — | 0 |
| (8) | 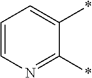 [SMILES: *c1cccnc1*] | — | 0 |
| (9) | 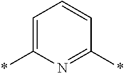 [SMILES: *c1cccc(*)n1] | — | 0 |

TABLE 1-2

| | X^{Dc} | Y^{Dc} | n^{Dc} |
|---|---|---|---|
| (10) | 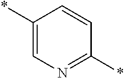 [SMILES: *c1ccc(*)nc1] | — | 0 |
| (11) | 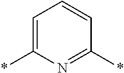 [SMILES: *c1cccc(*)n1] | — | 0 |
| (12) | 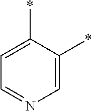 [SMILES: *c1ccncc1*] | — | 0 |
| (13) | 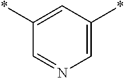 [SMILES: *c1cncc(*)c1] | — | 0 |
| (14) | 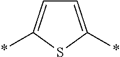 [SMILES: *c1ccc(*)s1] | — | 0 |
| (15) | 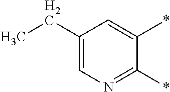 [SMILES: *c1cc(CC)cnc1*] | — | 0 |
| (16) | 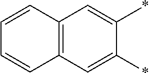 [SMILES: *c1cc2ccccc2cc1*] | — | 0 |
| (17) | 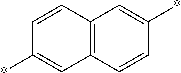 [SMILES: *c1ccc2cc(*)ccc2c1] | — | 0 |
| (18) | 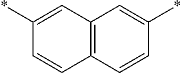 [SMILES: *c1ccc2ccc(*)cc2c1] | — | 0 |

TABLE 1-3

| | X^{Dc} | Y^{Dc} | n^{Dc} |
|---|---|---|---|
| (19) | 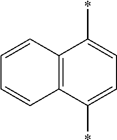 [SMILES: *c1ccc(*)c2ccccc12] | — | 0 |
| (20) | 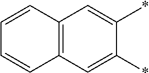 [SMILES: *c1cc2ccccc2cc1*] | — | 0 |
| (21) | 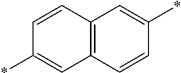 [SMILES: *c1ccc2cc(*)ccc2c1] | — | 0 |
| (22) | 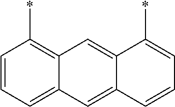 [SMILES: *c1cccc2cc3cccc(*)c3cc12] | — | 0 |
| (23) | 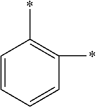 [SMILES: *c1ccccc1*] | Single bond | 1 |
| (24) | 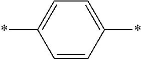 [SMILES: *c1ccc(*)cc1] | Single bond | 1 |
| (25) | 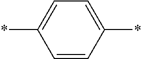 [SMILES: *c1ccc(*)cc1] | 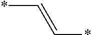 [SMILES: */C=C/*] | 1 |
| (26) | 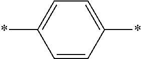 [SMILES: *c1ccc(*)cc1] | 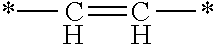 [SMILES: *C=C*] | 1 |

TABLE 1-4

| | X^{Dc} | Y^{Dc} | n^{Dc} |
|---|---|---|---|
| (27) | 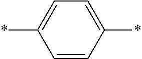 [SMILES: *c1ccc(*)cc1] | *—O—* | 1 |
| (28) | 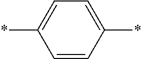 [SMILES: *c1ccc(*)cc1] | *—N═N—* | 1 |
| (29) | 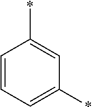 [SMILES: *c1cccc(*)c1] | *—N═N—* | 1 |
| (30) | 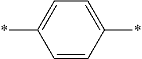 [SMILES: *c1ccc(*)cc1] | *—N═N—* | 1 |
| (31) | 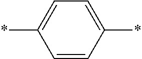 [SMILES: *c1ccc(*)cc1] | 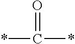 [SMILES: *C(*)=O] | 1 |
| (32) | 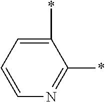 [SMILES: *c1cccnc1*] | Single bond | 1 |
| (33) | 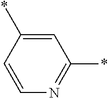 [SMILES: *c1ccnc(*)c1] | Single bond | 1 |
| (34) | 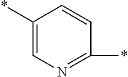 [SMILES: *c1ccc(*)nc1] | Single bond | 1 |
| (35) | 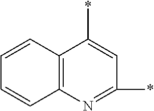 [SMILES: *c1cc(*)c2ccccc2n1] | Single bond | 1 |

TABLE 1-5

| | X^{Dc} | Y^{Dc} | n^{Dc} |
|---|---|---|---|
| (36) | 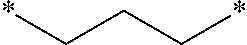 [SMILES: *CCC*] | — | 0 |
| (37) | 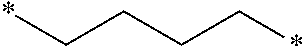 [SMILES: *CCCC*] | — | 0 |
| (38) | 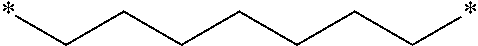 [SMILES: *CCCCCCC*] | — | 0 |
| (39) | 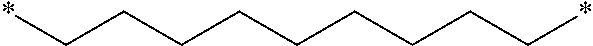 [SMILES: *CCCCCCCCC*] | — | 0 |
| (40) | 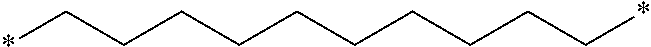 [SMILES: *CCCCCCCCCC*] | — | 0 |
| (41) | 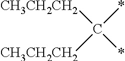 | — | 0 |
| (42) | 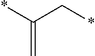 [SMILES: *CC(*)=C] | — | 0 |
| (43) | *—≡—* | — | 0 |
| (44) | 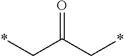 [SMILES: *CC(=O)C*] | — | 0 |

TABLE 1-6

| | X^{Dc} | Y^{Dc} | n^{Dc} |
|---|---|---|---|
| (45) | 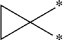 [SMILES: *C1(*)CC1] | — | 0 |
| (46) | 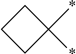 [SMILES: *C1(*)CCC1] | — | 0 |
| (47) | 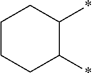 [SMILES: *C1CCCCC1*] | — | 0 |
| (48) | 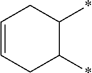 [SMILES: *C1CC=CCC1*] | — | 0 |
| (49) | 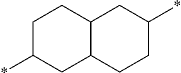 [SMILES: *C1CCC2CC(*)CCC2C1] | — | 0 |
| (50) | 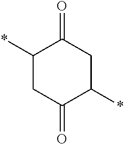 [SMILES: *C1CC(=O)C(*)CC1=O] | — | 0 |
| (51) | 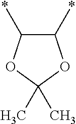 [SMILES: *C1OC(C)(C)OC1*] | — | 0 |
| (52) | 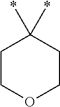 [SMILES: *C1(*)CCOCC1] | — | 0 |
| (53) | 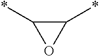 [SMILES: *C1OC1*] | — | 0 |

TABLE 1-7

| | X^{Dc} | Y^{Dc} | n^{Dc} |
|---|---|---|---|
| (54) | 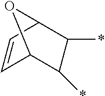 [SMILES: *C1C2C=CC(O2)C1*] | — | 0 |
| (55) | 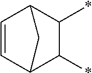 [SMILES: *C1C2C=CC(C2)C1*] | — | 0 |
| (56) | 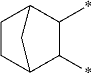 [SMILES: *C1C2CCC(C2)C1*] | — | 0 |
| (57) | 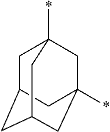 [SMILES: *C12CC3CC(C1)CC(*)(C3)C2] | — | 0 |

In particular, it is preferable that the combination of X^{Dc}, Y^{Dc}, and n^{Dc} be the combination (1) to (6), (16) to (21), (47), or (50), and more preferably (1) to (3), (16) to (21), or (47).

In a preferred embodiment, the compound represented by the formula (1) is 2-(4-carboxyphenyl)benzo[d]oxazole-5-carboxylic acid represented by the following formula (1-1) (hereinafter sometimes abbreviated to “ABO-100”).

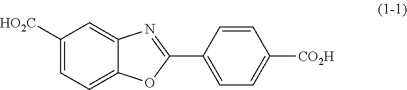 [SMILES: O=C(O)c1ccc(-c2nc3cc(C(=O)O)ccc3o2)cc1]

In another preferred embodiment, the compound represented by the formula (1) is 2-(4-carboxyphenyl)benzo[d]oxazole-5-carboxylic acid dichloride (hereinafter sometimes abbreviated to “ABO-001”).

The method of producing the compound represented by the formula (1) is not particularly limited. The compound may be produced by any conventionally known method. For example, ABO-100 and ABO-001 can be produced by a method described in Examples below.

One kind of the compound represented by the formula (1) may be used alone, or two or more kinds thereof may be used in combination.

In the formula (2), m is 1 or 2.

In the formula (2), when m is 1, R⁴ is a group represented by formula: ═C═O. In this case, —NR⁴ in the formula (2) is an isocyanate (—N═C═O) group.

In the formula (2), when m is 2, R⁴ is a hydrogen atom, a group represented by formula: —Si(R⁵)₃, or an acyl group. In this case, R⁵ is an alkyl group. In the formula (2), when there are a plurality of R⁴, they may be the same as or different from each other.

When R⁴ is a group represented by formula: —Si(R⁵)₃ (wherein R⁵ is an alkyl group), the alkyl group represented by R⁵ may be linear or branched. The number of carbon atoms in the alkyl group represented by R⁵ is preferably 1 to 10, more preferably 1 to 6, further preferably 1 to 4, still more preferably 1 to 3, and particularly preferably 1 or 2. In the group represented by formula: —Si(R⁵)₃, the three R⁵ may be the same as or different from each other. Specific preferable examples of the group represented by formula: —Si(R⁵)₃ may include a trimethylsilyl group.

The acyl group represented by R⁴ is a group represented by formula: —C(═O)—R⁶ (wherein R⁶ is an alkyl group or an aryl group). The alkyl group represented by R⁶ may be linear or branched. Examples of the aryl group represented by R⁶ may include a phenyl group, a naphthyl group, and an anthracenyl group. The number of carbon atoms in the acyl group represented by R⁴ is preferably 2 to 20, more preferably 2 to 13, and further preferably 2 to 7. Specific preferable examples of the acyl group represented by R⁴ may include an acetyl group, a propionyl group, a butyryl group, an isobutyryl group, a pivaloyl group, and a benzoyl group.

It is preferable that R⁴ be a hydrogen atom, an acyl group, or a group represented by —Si(R⁵)₃, more preferably a hydrogen atom or an acyl group, and further preferably a hydrogen atom.

In the formula (2), X^{Da} is a divalent aliphatic hydrocarbon group optionally having a substituent. The divalent aliphatic hydrocarbon group may be a saturated hydrocarbon group or an unsaturated hydrocarbon group. The number of carbon atoms in the group is preferably 1 to 60, more preferably 1 to 40, further preferably 1 to 30, still more preferably 1 to 20, and particularly preferably 1 to 10 or 1 to 6. The above-described number of carbon atoms does not include the number of carbon atoms in the substituent.

Examples of the divalent aliphatic hydrocarbon group in X^{Da} may include an alkylene group, a cycloalkylene group, an alkenylene group, a cycloalkenylene group, an alkynylene group, a cycloalkynylene group, an alkapolyenylene group (the number of double bonds is preferably 2 to 10, more preferably 2 to 6, further preferably 2 to 4, and still more preferably 2), an alkadiynylene group, and an alkatriynylene group. An alkylene group, a cycloalkylene group, an alkenylene group, and an alkynylene group are preferable, and an alkylene group and a cycloalkylene group are more preferable. In a preferable embodiment, X^{Da} is an alkylene group optionally having a substituent or a cycloalkylene group optionally having a substituent.

The number of carbon atoms in the alkylene group in X^{Da} is preferably 1 to 60, more preferably 1 to 40, further preferably 1 to 30, still more preferably 1 to 20, and particularly preferably 1 to 15, 1 to 12, 1 to 9, 1 to 6, or 1 to 3. The above-described number of carbon atoms does not include the number of carbon atoms in the substituent. Examples of the alkylene group may include a methylene group, an ethylene group, a propylene group, a butylene group, a pentylene group, a hexylene group, a heptylene group, an octylene group, a nonylene group, a decylene group, an undecylene group, a dodecylene group, a tridecylene group, a tetradecylene group, a pentadecylene group, a hexadecylene group, a heptadecylene group, an octadecylene group, a nonadecylene group, and an icosylene group.

The number of carbon atoms in the cycloalkylene group in X^{Da} is preferably 3 to 10, and more preferably 3 to 6. The above-described number of carbon atoms does not include the number of carbon atoms in the substituent. Examples of the cycloalkylene group may include a cyclopropylene group, a cyclobutylene group, a cyclopentylene group, and a cyclohexylene group.

The number of carbon atoms in the alkenylene group in X^{Da} is preferably 2 to 60, more preferably 2 to 40, further preferably 2 to 30, still more preferably 2 to 20, and particularly preferably 2 to 10, 2 to 6, or 2 or 3. The above-described number of carbon atoms does not include the number of carbon atoms in the substituent. Examples of the alkenylene group may include an ethenylene group, a propenylene group, a butenylene group, a pentenylene group, a hexenylene group, a heptenylene group, an octenylene group, a nonenylene group, a decenylene group, a undecenylene group, a dodecenylene group, a tridecenylene group, a tetradecenylene group, a pentadecenylene group, a hexadecenylene group, a heptadecenylene group, an octadecenylene group, a nonadecenylene group, and an icosenylene group.

The number of carbon atoms in the alkynylene group in X^{Da} is preferably 2 to 60, more preferably 2 to 40, further preferably 2 to 30, still more preferably 2 to 20, and particularly preferably 2 to 10, 2 to 6, or 2 or 3. The above-described number of carbon atoms does not include the number of carbon atoms in the substituent. Examples of the alkynylene group may include an ethynylene group, a propynylene group, a butynylene group, a pentynylene group, a hexynylene group, a heptynylene group, and an octynylene group.

The substituent that may be contained in the divalent aliphatic hydrocarbon group in X^{Da} is as described above. When the divalent aliphatic hydrocarbon group in X^{Da} has a plurality of substituents, the substituents may be the same as or different from each other. In particular, it is preferable that the substituent that may be contained in the divalent aliphatic hydrocarbon group in X^{Da} be one or more selected from the group consisting of a halogen atom, an alkyl group, an aryl group, an alkylidene group, a hydroxy group, an amino group, and an oxo group, and more preferably one or more selected from the group consisting of a halogen atom, an alkyl group, an aryl group, a hydroxy group, and an amino group. When the substituent is a halogen atom, a chlorine atom, a fluorine atom, and a bromine atom are preferable. When the substituent is an alkyl group, a C₁ to C₂₀ alkyl group is preferable, a C₁ to C₆ alkyl group is more preferable, a C₁ to C₃ alkyl group is further preferable, and a methyl group and an ethyl group are still more preferable. When the substituent is an aryl group, a phenyl group is preferable. When the substituent is an alkylidene group, a C₁ to C₆ alkylidene group, for example, a methylidene group, an ethylidene group, a propylidene group, a butylidene group, a pentylidene group, and a hexylidene group are preferable. These substituents may further have an additional substituent. Therefore, the substituent of the present application may include a fluoroalkyl group such as a trifluoromethyl group.

From the viewpoint of obtaining the polyamide compound having excellent thermal resistance, Y^{Da} in the formula (2) is an imino group optionally having a substituent, a divalent aromatic group optionally having a substituent, a divalent non-aromatic heterocyclic group optionally having a substituent, an oxyalkylene group optionally having a substituent, a group represented by formula: —S—, an alkylene group optionally having a substituent, or a cycloalkylene group optionally having a substituent.

Examples of the divalent aromatic group in Y^{Da} may include an arylene group and a heteroarylene group. An arylene group having 6 to 24 carbon atoms and a heteroarylene group having 3 to 21 carbon atoms are preferable, an arylene group having 6 to 18 carbon atoms and a heteroarylene group having 3 to 15 carbon atoms are more preferable, an arylene group having 6 to 14 carbon atoms and a heteroarylene group having 3 to 9 carbon atoms are further preferable, and an arylene group having 6 to 10 carbon atoms and a heteroarylene group having 3 to 6 carbon atoms are still more preferable. The above-described number of carbon atoms does not include the number of carbon atoms in the substituent.

Specific examples of the divalent aromatic group in Y^{Da} may include a phenylene group, a naphthylene group, an anthracenylene group, a thiophenediyl group, a pyrrolediyl group, a furandiyl group, a pyridinediyl group, a pyridazinediyl group, a pyrimidinediyl group, a pyrazinediyl group, a triazinediyl group, a quinolinediyl group, and an isoquinolinediyl group. From the viewpoint of obtaining the polyamide compound having excellent thermal resistance, it is particularly preferable that the divalent aromatic group in Y^{Da} be an arylene group having 6 to 12 carbon atoms, more preferably a phenylene group or a naphthylene group, and further preferably a phenylene group.

The number of carbon atoms in the divalent non-aromatic heterocyclic group in Y^{Da} is preferably 2 to 21, more preferably 2 to 15, further preferably 2 to 9, still more preferably 2 to 6, and particularly preferably 2 to 5. The above-described number of carbon atoms does not include the number of carbon atoms in the substituent. It is preferable that the divalent non-aromatic heterocyclic group in Y^{Da} contain, as a heteroatom constituting the heterocyclic ring, one or more selected from the group consisting of an oxygen atom, a sulfur atom, a nitrogen atom, a phosphorus atom, a boron atom, and a silicon atom, and more preferably one or more selected from the group consisting of an oxygen atom, a sulfur atom, and a nitrogen atom.

Specific examples of the divalent non-aromatic heterocyclic group in Y^{Da} may include an oxiranediyl group, an aziridinediyl group, an azetidinediyl group, an oxetanediyl group, a thietanediyl group, a pyrrolidinediyl group, a dihydrofurandiyl group, a tetrahydrofurandiyl group, a dioxolanediyl group, a tetrahydrothiophenediyl group, an imidazolidinediyl group, an oxazolidinediyl group, a piperidinediyl group, a dihydropyrandiyl group, a tetrahydropyrandiyl group, a tetrahydrothiopyrandiyl group, a morpholinediyl group, a thiomorpholinediyl group, a piperazinediyl group, a dihydrooxazinediyl group, a tetrahydrooxazinediyl group, a dihydropyrimidinediyl group, a tetrahydropyrimidinediyl group, and an exo-3,6-epoxy-1,2,3,6-tetrahydrophenylene group. From the viewpoint of obtaining the polyamide compound having excellent thermal resistance, it is particularly preferable that the divalent non-aromatic heterocyclic group in Y^{Da} be a divalent non-aromatic heterocyclic group containing a nitrogen atom as a heteroatom constituting the heterocyclic ring, more preferably a piperidinediyl group, a piperazinediyl group, a dihydropyrimidinediyl group, or a tetrahydropyrimidinediyl group, and further preferably a piperazinediyl group.

The number of carbon atoms in the oxyalkylene group in Y^{Da} is preferably 1 to 20, more preferably 1 to 12, further preferably 2 to 6, and still more preferably 2 to 4. The above-described number of carbon atoms does not include the number of carbon atoms in the substituent.

Specific examples of the oxyalkylene group in Y^{Da} may include an oxyethylene group, an oxypropylene group, an oxybutylene group, an oxypentylene group, an oxyhexylene group, an oxyheptylene group, an oxyoctylene group, an oxynonylene group, and an oxydecylene group.

The number of carbon atoms in the alkylene group in Y^{Da} is preferably 1 to 10, more preferably 1 to 6, and further preferably 1 to 3. The above-described number of carbon atoms does not include the number of carbon atoms in the substituent. From the viewpoint of obtaining the polyamide compound having excellent thermal resistance, it is particularly preferable that the alkylene group in Y^{Da} be a methylene group.

The number of carbon atoms in the cycloalkylene group in Y^{Da} is preferably 3 to 10, and more preferably 3 to 6. The above-described number of carbon atoms does not include the number of carbon atoms in the substituent. Specific examples of the cycloalkylene group in Y^{Da} may include a cyclopropylene group, a cyclobutylene group, a cyclopentylene group, and a cyclohexylene group. From the viewpoint of obtaining the polyamide compound having excellent thermal resistance, it is particularly preferable that the cycloalkylene group in Y^{Da} be a cyclohexylene group.

The substituent that may be contained in the divalent group in Y^{Da} is as described above. When the divalent group in Y^{Da} has a plurality of substituents, the substituents may be the same as or different from each other. In particular, it is preferable that the substituent that may be contained in the divalent group in Y^{Da} be one or more selected from the group consisting of a halogen atom, an alkyl group, an aryl group, an alkylidene group, a hydroxy group, an amino group, and an oxo group, and more preferably one or more selected from the group consisting of a halogen atom, an alkyl group, an aryl group, a hydroxy group, and an amino group. When the substituent is a halogen atom, a chlorine atom, a fluorine atom, and a bromine atom are preferable. When the substituent is an alkyl group, a C₁ to C₂₀ alkyl group is preferable, a C₁ to C₆ alkyl group is more preferable, a C₁ to C₃ alkyl group is further preferable, and a methyl group is still more preferable. When the substituent is an aryl group, a phenyl group is preferable. When the substituent is an alkylidene group, a C₁ to C₆ alkylidene group, for example, a methylidene group, an ethylidene group, a propylidene group, a butylidene group, a pentylidene group, and a hexylidene group are preferable. These substituents may further have an additional substituent.

When Y^{Da} is a methylene group having two substituents, the substituents may be bonded together to form a ring. In this case, examples of Y^{Da} may include a 9H-fluorene-9,9-diyl group and a 1,1-cyclohexanediyl group.

In the formula (2), Z^{Da} is a divalent aliphatic hydrocarbon group optionally having a substituent or a single bond.

The divalent aliphatic hydrocarbon group in Z^{Da} may be a saturated hydrocarbon group or an unsaturated hydrocarbon group. The number of carbon atoms in the group is preferably 1 to 60, more preferably 1 to 40, further preferably 1 to 30, and still more preferably 1 to 20. The above-described number of carbon atoms does not include the number of carbon atoms in the substituent.

Examples of the divalent aliphatic hydrocarbon group in Z^{Da} may include an alkylene group, a cycloalkylene group, an alkenylene group, a cycloalkenylene group, an alkynylene group, a cycloalkynylene group, an alkapolyenylene group (the number of double bonds is preferably 2 to 10, more preferably 2 to 6, further preferably 2 to 4, and still more preferably 2), an alkadiynylene group, and an alkatriynylene group. An alkylene group, a cycloalkylene group, an alkenylene group, and an alkynylene group are preferable, an alkylene group and a cycloalkylene group are more preferable, and an alkylene group is further preferable.

Specific examples of the alkylene group, cycloalkylene group, alkenylene group, and alkynylene group in Z^{Da} are the same as those described about the alkylene group, cycloalkylene group, alkenylene group, and alkynylene group in X^{Da}.

The substituent that may be contained in the divalent aliphatic hydrocarbon group in Z^{Da} is as described above. When the divalent aliphatic hydrocarbon group in Z^{Da} has a plurality of substituents, the substituents may be the same as or different from each other. In particular, it is preferable that the substituent that may be contained in the divalent aliphatic hydrocarbon group in Z^{Da} be one or more selected from the group consisting of a halogen atom, an alkyl group, an aryl group, an alkylidene group, a hydroxy group, an amino group, and an oxo group, and more preferably one or more selected from the group consisting of a halogen atom, an alkyl group, an aryl group, a hydroxy group, and an amino group. When the substituent is a halogen atom, a chlorine atom, a fluorine atom, and a bromine atom are preferable. When the substituent is an alkyl group, a C₁ to C₂₀ alkyl group is preferable, a C₁ to C₆ alkyl group is more preferable, and a C₁ to C₃ alkyl group is further preferable. When the substituent is an aryl group, a phenyl group is preferable. When the substituent is an alkylidene group, a C₁ to C₆ alkylidene group, for example, a methylidene group, an ethylidene group, a propylidene group, a butylidene group, a pentylidene group, and a hexylidene group are preferable. These substituents may further have the additional substituent.

In a preferred embodiment, Z^{Da} in the formula (2) is an alkylene group optionally having a substituent, a cycloalkylene group optionally having a substituent, or a single bond.

In the formula (2), n^{Da} is an integer of 0 to 5, preferably an integer of 0 to 4, more preferably an integer of 0 to 3, and still more preferably an integer of 0 to 2. When there are a plurality of Y^{Da}, they may be the same as or different from each other. When there are a plurality of Z^{Da}, they may be the same as or different from each other.

In the formula (2), when n^{Da} is 0, it is preferable that X^{Da} be an alkylene group optionally having a substituent or a cycloalkylene group optionally having a substituent.

In the formula (2), when n^{Da} is an integer of 1 to 5, it is preferable that X^{Da} be an alkylene group optionally having a substituent or a cycloalkylene group optionally having a substituent, Y^{Da} be an imino group optionally having a substituent, a divalent aromatic group optionally having a substituent, a divalent non-aromatic heterocyclic group optionally having a substituent, an oxyalkylene group optionally having a substituent, a group represented by formula: —S—, an alkylene group optionally having a substituent, or a cycloalkylene group optionally having a substituent, and Z^{Da} be an alkylene group optionally having a substituent, a cycloalkylene group optionally having a substituent, or a single bond.

In one preferred embodiment, in the formula (2),

i) n^{Da} is 0, and X^{Da} is an alkylene group having 1 to 15 carbon atoms and optionally having a substituent or a cycloalkylene group having 3 to 10 carbon atoms and optionally having a substituent, or

ii) n^{Da} is 1 or 2, X^{Da} is an alkylene group having 1 to 6 carbon atoms and optionally having a substituent or a cycloalkylene group having 3 to 10 carbon atoms and optionally having a substituent, Y^{Da} is an imino group optionally having a substituent, an oxyalkylene group having 1 to 6 carbon atoms and optionally having a substituent, a divalent non-aromatic heterocyclic group having a nitrogen atom as a heteroatom constituting the heterocyclic ring and 2 to 5 carbon atoms and optionally having a substituent, or a phenylene group optionally having a substituent, and Z^{Da} is an alkylene group having 1 to 3 carbon atoms and optionally having a substituent a cycloalkylene group having 3 to 10 carbon atoms and optionally having a substituent, or a single bond.

In one preferred embodiment, in the formula (2),

i) n^{Da} is 0, and X^{Da} is an alkylene group having 1 to 15 carbon atoms and optionally having one or more substituents selected from the group consisting of a halogen atom, an alkyl group, an aryl group, an alkylidene group, a hydroxy group, an amino group, and an oxo group, or a cycloalkylene group having 3 to 10 carbon atoms and optionally having one or more substituents selected from the group consisting of a halogen atom, an alkyl group, an aryl group, an alkylidene group, a hydroxy group, an amino group, and an oxo group, or

ii) n^{Da} is 1 or 2, X^{Da} is an alkylene group having 1 to 6 carbon atoms and optionally having one or more substituents selected from the group consisting of a halogen atom, an alkyl group, an aryl group, an alkylidene group, a hydroxy group, an amino group, and an oxo group, or a cycloalkylene group having 3 to 10 carbon atoms and optionally having one or more substituents selected from the group consisting of a halogen atom, an alkyl group, an aryl group, an alkylidene group, a hydroxy group, an amino group, and an oxo group, Y^{Da} is an imino group optionally having one or more substituents selected from the group consisting of a halogen atom, an alkyl group, an aryl group, a hydroxy group, and an amino group, an oxyalkylene group having 1 to 6 carbon atoms and optionally having one or more substituents selected from the group consisting of a halogen atom, an alkyl group, an aryl group, an alkylidene group, a hydroxy group, an amino group, and an oxo group, a divalent non-aromatic heterocyclic group having a nitrogen atom as a heteroatom constituting the heterocyclic ring and 2 to 5 carbon atoms and optionally having one or more substituents selected from the group consisting of a halogen atom, an alkyl group, an aryl group, an alkylidene group, a hydroxy group, an amino group, and an oxo group, or a phenylene group optionally having one or more substituents selected from the group consisting of a halogen atom, an alkyl group, an aryl group, a hydroxy group, and an amino group, and Z^{Da} is an alkylene group having 1 to 3 carbon atoms and optionally having one or more substituents selected from the group consisting of a halogen atom, an alkyl group, an aryl group, an alkylidene group, a hydroxy group, an amino group, and an oxo group, a cycloalkylene group having 3 to 10 carbon atoms and optionally having one or more substituents selected from the group consisting of a halogen atom, an alkyl group, an aryl group, an alkylidene group, a hydroxy group, an amino group, and an oxo group, or a single bond.

The compound represented by the formula (2) may be in the form of an acid salt. Examples of the acid used to form an acid salt may include an inorganic acid and an organic acid. Preferable examples of the inorganic acid may include hydrochloric acid and sulfuric acid. Preferable examples of the organic acid may include monovalent or multivalent carboxylic acid having 1 to 10 carbon atoms (for example, glycolic acid and citric acid), methylsulfuric acid, ethylsulfuric acid, and p-toluenesulfonic acid. When the compound represented by the formula (2) is in the form of an acid salt, it is preferable that the form be a form of a hydrochloride.

In a preferred embodiment, the compound represented by the formula (2) is one or more selected from the group consisting of compounds represented by the following formulae (2-1) to (2-36).

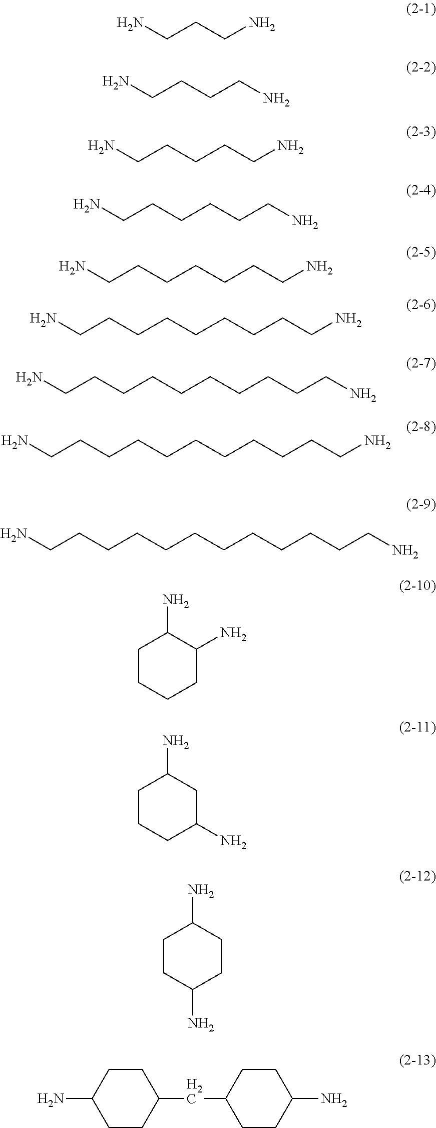

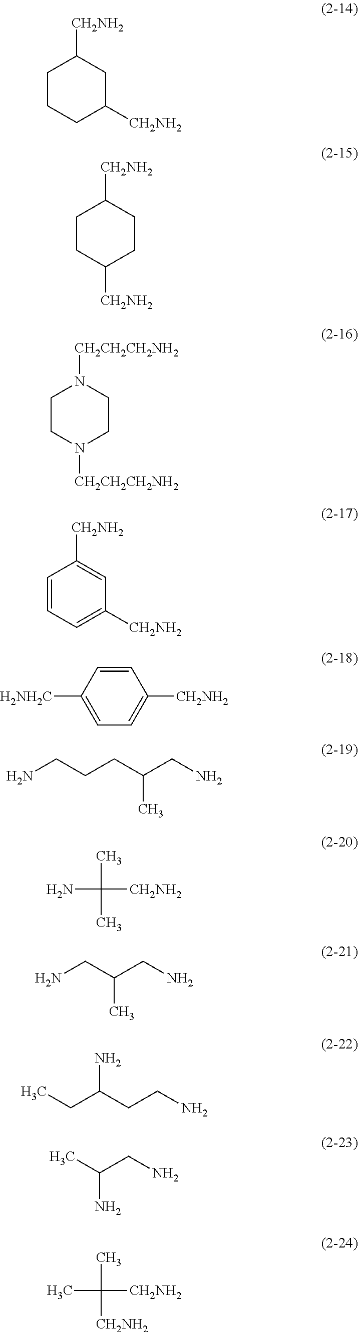

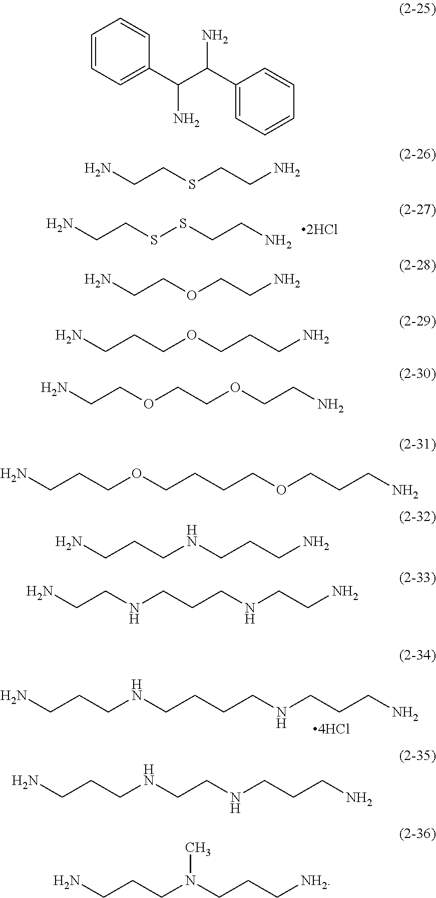

X^{Da}, Y^{Da}, Z^{Da}, and n^{Da} in the formulae (2-1) to (2-36) are as shown in Tables 2-1 to 2-5 below. In the Tables, * indicates the connection point to the rest of the compound.

TABLE 2-1

| | X^{Da} | Y^{Da} | Z^{Da} | n^{Da} | Name of compound |
|---|---|---|---|---|---|
| (2-1) | 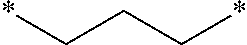 [SMILES: *CCC*] | — | — | 0 | 1,3-diamino propane |
| (2-2) | 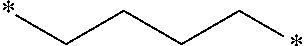 [SMILES: *CCCC*] | — | — | 0 | 1,4-diamino butane |
| (2-3) | 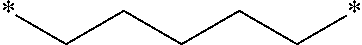 [SMILES: *CCCCC*] | — | — | 0 | 1,5-diamino pentane |
| (2-4) | 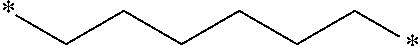 [SMILES: *CCCCCC*] | — | — | 0 | 1,6-diamino hexane |
| (2-5) | 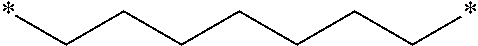 [SMILES: *CCCCCCC*] | — | — | 0 | 1,7-diamino heptane |
| (2-6) | 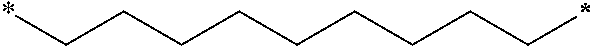 [SMILES: *CCCCCCCCC*] | — | — | 0 | 1,9-diamino nonane |
| (2-7) | 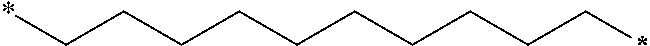 [SMILES: *CCCCCCCCCC*] | — | — | 0 | 1,10-diamino decane |
| (2-8) | 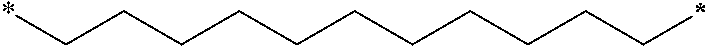 [SMILES: *CCCCCCCCCCC*] | — | — | 0 | 1,11-diamino undecane |
| (2-9) | 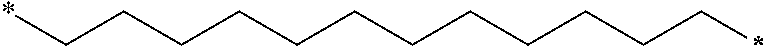 [SMILES: *CCCCCCCCCCCC*] | — | — | 0 | 1,12-diamino dodecane |

TABLE 2-2

| | X^{Da} | Y^{Da} | Z^{Da} | n^{Da} | Name of compound |
|---|---|---|---|---|---|
| (2-10) | 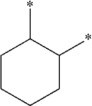 [SMILES: *C1CCCCC1*] | — | — | 0 | 1,2-diamino cyclohexane |
| (2-11) | 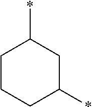 [SMILES: *C1CCCC(*)C1] | — | — | 0 | 1,3-diamino cyclohexane |
| (2-12) | 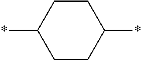 [SMILES: *C1CCC(*)CC1] | — | — | 0 | 1,4-diamino cyclohexane |
| (2-13) | 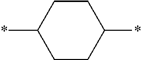 [SMILES: *C1CCC(*)CC1] | 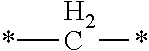 [SMILES: *C*] | 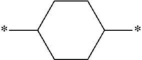 [SMILES: *C1CCC(*)CC1] | 1 | 4,4′-methylenebis (cyclohexylamine) |
| (2-14) | 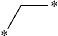 [SMILES: *C*] | 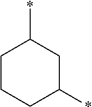 [SMILES: *C1CCCC(*)C1] | 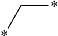 [SMILES: *C*] | 1 | 1,3-bis(aminomethyl) cyclohexane |
| (2-15) | 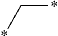 [SMILES: *C*] | 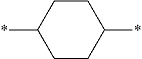 [SMILES: *C1CCC(*)CC1] | 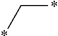 [SMILES: *C*] | 1 | 1,4-bis-(aminomethyl) cyclohexane |
| (2-16) | 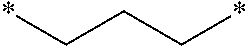 [SMILES: *CCC*] | 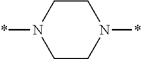 [SMILES: *N1CCN(*)CC1] | 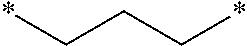 [SMILES: *CCC*] | 1 | 1,4-bis-(aminopropyl) piperazine |

TABLE 2-3

| | X^{Da} | Y^{Da} | Z^{Da} | n^{Da} | Name of compound |
|---|---|---|---|---|---|
| (2-17) | 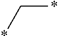 [SMILES: *C*] | 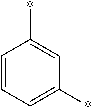 [SMILES: *c1cccc(*)c1] | 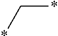 [SMILES: *C*] | 1 | m-xylylene diamine |
| (2-18) | 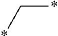 [SMILES: *C*] | 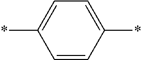 [SMILES: *c1ccc(*)cc1] | 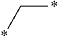 [SMILES: *C*] | 1 | p-xylylene diamine |
| (2-19) | 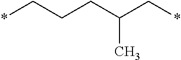 [SMILES: *CCCC(C)C*] | — | — | 0 | 1,5-diamino-2- methylpentane |
| (2-20) | 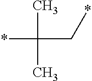 [SMILES: *CC(*)(C)C] | — | — | 0 | 1,2-diamino-2- methylpropane |
| (2-21) | 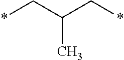 [SMILES: *CC(C)C*] | — | — | 0 | 1,3-diamino-2- methylpropane |
| (2-22) | 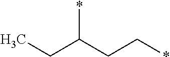 [SMILES: *CCC(*)CC] | — | — | 0 | 1,3-diamino pentane |
| (2-23) | 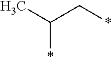 [SMILES: *CC(*)C] | — | — | 0 | 1,2-diamino propane |
| (2-24) | 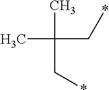 [SMILES: *CC(C)(C)C*] | — | — | 0 | 1,3-diamino-2,2- dimethylpropane |

TABLE 2-4

| | X^{Da} | Y^{Da} | Z^{Da} | n^{Da} | Name of compound |
|---|---|---|---|---|---|
| (2-25) | 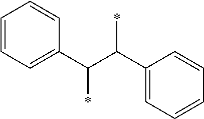 [SMILES: *C(c1ccccc1)C(*)c1ccccc1] | — | — | 0 | 1,2-diphenyl Ethylene-diamine |
| (2-26) | 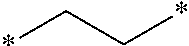 [SMILES: *CC*] | 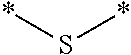 [SMILES: *S*] | 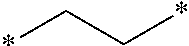 [SMILES: *CC*] | 1 | 2,2′-thiobis (ethylamine) |
| (2-27)* | 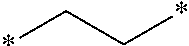 [SMILES: *CC*] | 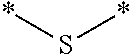 [SMILES: *S*] | Single bond | 2 | cystamine dihydro-chloride |
| | | | 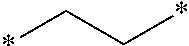 [SMILES: *CC*] | | |
| (2-28) | 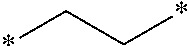 [SMILES: *CC*] | 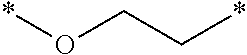 [SMILES: *CCO*] | Single bond | 1 | 2,2′-oxybis (ethylamine) |
| (2-29) | 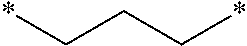 [SMILES: *CCC*] | 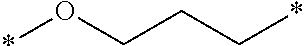 [SMILES: *CCCO*] | Single bond | 1 | bis(3-amino propyl)ether |
| (2-30) | 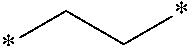 [SMILES: *CC*] | 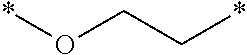 [SMILES: *CCO*] | Single bond | 2 | 1,2-bis(2- aminoethoxy)-ethane |
| (2-31) | 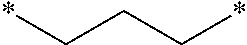 [SMILES: *CCC*] | 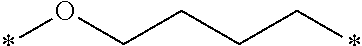 [SMILES: *CCCCO*] | Single bond | 2 | 1,4-butanediol bis(3-amino propyl)ether |
| | | 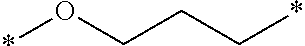 [SMILES: *CCCO*] | | | |

*Form of hydrochloride

TABLE 2-5

| | X^{Da} | Y^{Da} | Z^{Da} | n^{Da} | Name of compound |
|---|---|---|---|---|---|
| (2-32) | 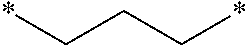 [SMILES: *CCC*] | 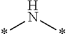 [SMILES: *N*] | 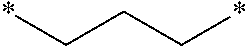 [SMILES: *CCC*] | 1 | 3,3′-diamino dipropylamine |
| (2-33) | 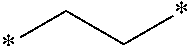 [SMILES: *CC*] | 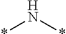 [SMILES: *N*] | 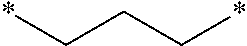 [SMILES: *CCC*] | 2 | N,N′-bis(amino ethyl)-1,3- propanediamine |
| | | | 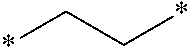 [SMILES: *CC*] | | |
| (2-34)* | 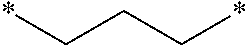 [SMILES: *CCC*] | 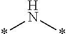 [SMILES: *N*] | 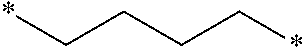 [SMILES: *CCCC*] | 2 | N,N′-bis(3-amino propyl)-1,4-butane diamine tetrahydrochloride |
| | | | 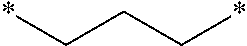 [SMILES: *CCC*] | | |
| (2-35) | 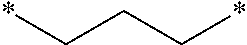 [SMILES: *CCC*] | 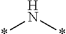 [SMILES: *N*] | 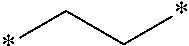 [SMILES: *CC*] | 2 | N,N′-bis(3-amino propyl)ethylene diamine |
| | | | 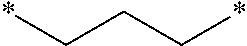 [SMILES: *CCC*] | | |
| (2-36) | 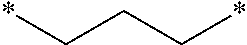 [SMILES: *CCC*] | 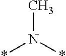 [SMILES: *N(*)C] | 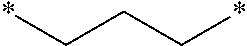 [SMILES: *CCC*] | 1 | N,N′-bis(3-amino propyl)methylamine |

*Form of hydrochloride

One kind of the compound represented by the formula (2) may be used alone, or two or more kinds thereof may be used in combination.

In a preferred embodiment, the compound represented by the formula (2) is a compound represented by the formula (2-3), (2-4), (2-6), (2-13), (2-16), (2-18), (2-23), (2-28), or (2-32).

The polyamide compound of the present invention may be produced using the compound represented by the formula (1) and the compound represented by the formula (2) as well as another compound as raw materials as long as they do not inhibit the effects of the present invention.

Examples of the other compound may include aromatic dicarboxylic acids, and salts thereof, esters thereof, and halides thereof. In a preferred embodiment, the polyamide compound of the present invention can be obtained by a reaction of the compound represented by the formula (1), the compound represented by the formula (2), and one or more selected from an aromatic dicarboxylic acid, and a salt thereof, ester thereof, and halide thereof.

The number of carbon atoms in an aromatic dicarboxylic acid usable in production of the polyamide compound of the present invention is preferably 8 to 18, more preferably 8 to 16, and further preferably 8 to 14. Examples of a salt of the aromatic dicarboxylic acid may include alkali metal salts. A lithium salt, a sodium salt, a potassium salt, and a cesium salt are preferable, and a potassium salt is more preferable. Examples of an ester of the aromatic dicarboxylic acid may include a C₁ to C₁₀ alkyl ester (preferably a C₁ to C₆ alkyl ester, and more preferably a C₁ to C₄ alkyl ester), and a C₆ to C₁₈ allyl ester (preferably a C₆ to C₁₄ allyl ester, and more preferably a C₆ to C₁₀ allyl ester). Examples of a halide of the aromatic dicarboxylic acid may include a fluoride, a chloride, a bromide, and an iodide. A chloride is preferable.

Examples of the aromatic dicarboxylic acid, and the salt thereof, ester thereof, and halide thereof that are usable in production of the polyamide compound of the present invention may include terephthalic acid, isophthalic acid, 2,6-naphthalenedicarboxylic acid, 4,4′-biphenyl dicarboxylic acid, 4,4′-dicarboxydiphenyl ether, 4,4′-dicarboxydiphenyl sulfone, dipotassium terephthalate, dipotassium isophthalate, dimethyl terephthalate, dimethyl isophthalate, terephthalic acid dichloride, and isophthalic acid dichloride. Among them, terephthalic acid, isophthalic acid, and 2,6-naphthalene dicarboxylic acid are preferable.

The polyamide compound of the present invention has one or more selected from the group consisting of structural units represented by the following formulae (i) to (iv).

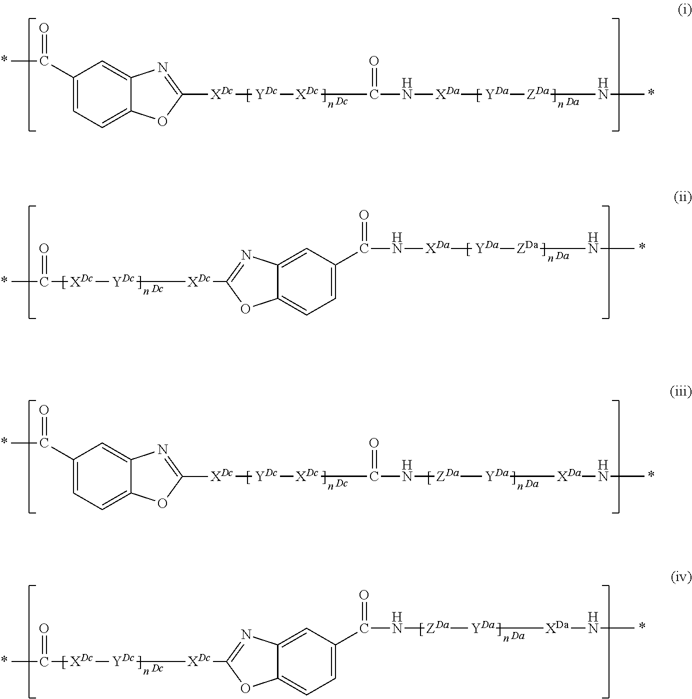

wherein in formulae (i) to (iv), X^{Dc}, Y^{Dc}, X^{Da}, Y^{Da}, Z^{Da}, n^{Dc}, and n^{Da} represent the same meanings as described above, and * represents the connection point to the rest of the compound.

Preferable examples of X^{Dc}, Y^{Dc}, X^{Da}, Y^{Da}, and Z^{Da} preferable ranges of n^{Dc} and n^{Da} are as described above.

When the polyamide compound of the present invention is produced using the compound represented by the formula (1) and the compound represented by the formula (2) as well as the other compound as raw materials, the polyamide compound of the present invention may further have a structural unit derived from the other compound. For example, when the aromatic dicarboxylic acid is used as the other compound, the polyamide compound of the present invention may further have one or more selected from the group consisting of structural units represented by the following formulae (v) to (vi).

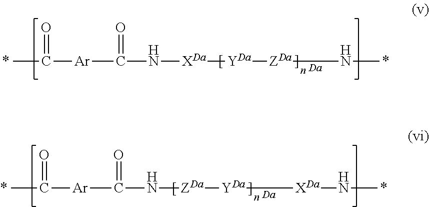

wherein in the formulae (v) and (vi), X^{Da}, Y^{Da}, Z^{Da}, and n^{Da} represent the same meanings as described above, Ar represents an arylene group, and * represents the connection point to the rest of the compound.

In the formulae (v) and (vi), the arylene group represented by Ar represent an arylene group derived from the aromatic dicarboxylic acid used as the “other compound.” The number of carbon atoms in the arylene group represented by Ar is preferably 6 to 16, more preferably 6 to 14, and further preferably 6 to 12. Specific preferable examples of the arylene group represented by Ar may include a 1,4-phenylene group, a 1,3-phenylene group, and a 2,6-naphthylene group.

When the polyamide compound of the present invention is produced, the ratio of the amount (mole) of the other compounds to the total amount (mole) of the compound represented by the formula (1) and the compound represented by the formula (2), that is, the molar ratio of [the other compounds]/[the compound represented by the formula (1)]+[the compound represented by the formula (2)] is preferably 0.5 or less, more preferably 0.3 or less, further preferably 0.2 or less, and still more preferably 0.1 or less, from the viewpoint of obtaining the polyamide compound having excellent thermal resistance. Although the lower limit of the molar ratio is not particularly limited, it may be 0.

When the aromatic dicarboxylic acid above is used as the other compound, the ratio of the amount (mole) of the compound represented by the formula (2) to the total amount (mole) of the compound represented by the formula (1) and the aromatic dicarboxylic acid, that is, the molar ratio of [the compound represented by the formula (2)]/[the compound represented by the formula (1)]+[the aromatic dicarboxylic acid] is preferably 0.9 to 1.1, and more preferably 0.95 to 1.05.

The compound represented by the formula (1), the compound represented by the formula (2), and if necessary, the other compound may be reacted in the presence of a condensation agent. The condensation agent is not particularly limited as long as it promotes an amidation reaction. Examples of the condensation agent may include diphenyl chlorophosphate, tosyl chloride, triphenylphosphine dichloride, thionyl chloride, picryl chloride, hexachlorocyclotriphosphazene, phosphorus trichloride, and triphenyl phosphite. One kind of the condensation agent may be used alone, or two or more kinds thereof may be used in combination.

The compound represented by the formula (1), the compound represented by the formula (2), and if necessary, the other compound may be reacted in the presence of a catalyst. The catalyst is not particularly limited as long as it promotes an amidation reaction. Examples of the catalyst may include oxides and salts of metals such as lead, zinc, manganese, calcium, lithium, cobalt, magnesium, and titanium. One kind of the catalyst may be used alone, or two or more kinds thereof may be used in combination.

The condensation agent and the catalyst may be used in combination. In this case, one kind of each of the condensation agent and the catalyst (that is, combination of one kind of the condensation agent and one kind of the catalyst) may be used alone, or two or more kinds of each of the condensation agents and the catalysts (that is, combination of two or more kinds of the condensation agents and two or more kinds of the catalysts) may be used in combination.

The reaction may be performed in an organic solvent. Examples of the organic solvent may include pyridine, N,N-dimethyl formamide, N,N-dimethyl acetamide, N-methyl-2-pyrrolidone, carbon tetrachloride, hexachloroethane, 1,2-dichloroethane, chlorobenzene, and o-dichlorobenzene. One kind of the organic solvent may be used alone, or two or more kinds thereof may be used in combination.

In a solution polymerization method in which an amidation reaction is performed in the organic solvent, it is preferable that the reaction be performed in an inert gas atmosphere such as argon and nitrogen and that the reaction be performed under atmospheric pressure (normal pressure).

In a melting polymerization method in which an amidation reaction is performed using a raw material in a molten state without the organic solvent, resulting in condensation polymerization, it is preferable that the reaction be performed in an inert gas atmosphere such as argon and nitrogen and that the reaction be performed under reduced pressure. The pressure is not particularly limited as long as the amidation reaction proceeds. The pressure is preferably 750 Torr or less, more preferably 300 Torr or less, and further preferably 50 Torr or less. Although the lower limit of the pressure is not particularly limited, it is generally 0.1 Torr or more.

The reaction temperature is not particularly limited as long as the amidation reaction proceeds. In the solution polymerization method, the reaction temperature is preferably −10 to 200° C., more preferably 0 to 150° C., further preferably 20 to 120° C., and still more preferably 20 to 100° C. In the melting polymerization method, the reaction temperature is preferably 100 to 400° C., more preferably 150 to 350° C., and further preferably 150 to 300° C.

The reaction time depends on the kind of the raw material, the reaction temperature, and the like. The reaction time is preferably 0.1 to 24 hours, more preferably 0.5 to 18 hours, and further preferably 1 to 18 hours.

The extrapolated glass transition onset temperature (T_{ig}) of the polyamide compound of the present invention is preferably 90° C. or higher, more preferably 110° C. or higher, further preferably 130° C. or higher, still more preferably 140° C. or higher, and particularly preferably 160° C. or higher. The polyamide compound of the present invention obtained by a reaction of the compound represented by the formula (1) with the compound represented by the formula (2) can achieve a high T_{ig}, for example, a T_{ig} of 190° C. or higher, 200° C. or higher, 210° C. or higher, 220° C. or higher, 230° C. or higher, 240° C. or higher, 250° C. or higher, or 260° C. or higher. Although the upper limit of T_{ig} is not particularly limited, it is usually 400° C. or lower, 385° C. or lower, 370° C. or lower, 355° C. or lower, 340° C. or lower, or 330° C. or lower.

The T_{ig} can be determined, for example, by a differential scanning calorimeter.

The glass transition temperature (T_{mg}) of the polyamide compound of the present invention is preferably 100° C. or higher, 120° C. or higher, or 140° C. or higher, more preferably 150° C. or higher, further preferably 170° C. or higher, and still more preferably 190° C. or higher. The polyamide compound of the present invention obtained by a reaction of the compound represented by the formula (1) with the compound represented by the formula (2) can achieve a high T_{mg}, for example, a T_{mg} of 200° C. or higher, 210° C. or higher, 220° C. or higher, 230° C. or higher, 240° C. or higher, 250° C. or higher, 260° C. or higher, or 270° C. or higher. Although the upper limit of T_{mg} is not particularly limited, it is usually 400° C. or lower.

T_{mg} can be determined, for example, by a differential scanning calorimeter.

The melting point (Tₘ) of the polyamide compound of the present invention is preferably 230° C. or higher, 250° C. or higher, 260° C. or higher, or 280° C. or higher, more preferably 300° C. or higher, further preferably 310° C. or higher, and still more preferably 320° C. or higher. The polyamide compound of the present invention obtained by a reaction of the compound represented by the formula (1) with the compound represented by the formula (2) can achieve a high Tₘ, for example, a Tₘ of 330° C. or higher, 340° C. or higher, 350° C. or higher, or 360° C. or higher. Although the upper limit of Tₘ is not particularly limited, it is usually 500° C. or lower.

The Tₘ can be determined, for example, by a differential scanning calorimeter.

The 5% mass decrease temperature (T_{d}; temperature at which the amount of the polyamide compound is decreased by 5% during heating from room temperature at a certain temperature increasing rate) of the polyamide compound of the present invention is preferably 250° C. or higher, and more preferably 270° C. or higher. The polyamide compound of the present invention obtained by a reaction of the compound represented by the formula (1) with the compound represented by the formula (2) can achieve a high T_{d}, for example, a T_{d} of 280° C. or higher, 290° C. or higher, 300° C. or higher, 310° C. or higher, 320° C. or higher, 330° C. or higher, or 340° C. or higher. Although the upper limit of T_{d} is not particularly limited, it is usually 500° C. or lower.

The T_{d} can be determined, for example, by a thermogravimetric measurement device.

Since the polyamide compound of the present invention has excellent thermal resistance, the polyamide compound can be suitably used as an engineering plastic. The polyamide compound of the present invention can be suitably used as an engineering plastic, for example, in fields of automobiles, airplanes, fields of electronics and electronic devices, fields of machines, and the like (medical care and care equipment, heat-resistant sheets, heat-resistant fibers, etc.). Specific examples of applications in the fields of automobiles and airplanes may include an engine cover, an intake manifold, a door mirror stay, an accelerator pedal, an industrial fastener, an arm rest, a seat belt part, a door handle, a power steering oil reservoir tank, a radiator grille, and a cooling fan. Examples of applications in the fields of electrical and electronic devices may include a gear, a hub, a coil bobbin, a connector, a motor bracket, a ferrite binder, a magnet switch part, a circuit breaker housing, various types of plugs, and a crimping terminal. Examples of applications in the field of machines may include a bearing, a bearing retainer, a gear, a fan, an impeller, a filter bowl, a pulley, and a caster. The polyamide compound of the present invention may also be used for applications such as a toy, a packing material (bag, film, tube, etc.), a food container, a fiber for clothes, and a buffer material.

### Method of Producing Polyamide Compound.

The present invention also provides a method of producing a polyamide compound.

In one embodiment, a method of producing a polyamide compound of the present invention includes a step of reacting the compound represented by the formula (1) with the compound represented by the formula (2).

The compound represented by the formula (1), the compound represented by the formula (2), and the reaction conditions (catalyst, organic solvent, molar ratio, reaction temperature, reaction pressure, reaction time, etc.) are as described above.

When the polyamide compound of the present invention is produced, the ratio of the amount (mole) of the compound represented by the formula (1) to the amount (mole) of the compound represented by the formula (2), that is, the molar ratio of [the compound represented by the formula (1)]/[the compound represented by the formula (2)] is 10/1 to 1/10, from the viewpoint of obtaining the polyamide compound having excellent thermal resistance. The molar ratio of [the compound represented by the formula (1)]/[the compound represented by the formula (2)] is preferably 3/1 to 1/3, more preferably 1.5/1 to 1/1.5, and further preferably 1/1.

In the method of producing a polyamide compound of the present invention, the polyamide compound may be produced using the compound represented by the formula (1) and the compound represented by the formula (2) as well as the other compound as raw materials as long as they do not inhibit the effects of the present invention. Examples of the other compound may include aromatic dicarboxylic acids, and salts thereof, esters thereof, and halides thereof.

In a preferred embodiment, the method of producing a polyamide compound of the present invention includes a step of reacting the compound represented by the formula (1), the compound represented by the formula (2), and one or more selected from an aromatic dicarboxylic acid, and a salt thereof, ester thereof, and halide thereof.

The aromatic dicarboxylic acid, and the salt thereof, ester thereof, and halide thereof are as described above.

When the polyamide compound is produced using the compound represented by the formula (1), the compound represented by the formula (2), and if necessary, the other compound, a solution polymerization method in which an amidation reaction is performed in an organic solvent or a melting polymerization method in which an amidation reaction is performed using a raw material in a molten state without the organic solvent, resulting in condensation polymerization may be used. Alternatively, the polyamide compound may be produced through an interfacial polymerization method.

The procedures and conditions of the polymerization methods are well known in the art.

Other features of the invention will become apparent in the course of the following descriptions of exemplary embodiments which are given for illustration of the invention and are not intended to be limiting thereof.

### EXAMPLES

Unless otherwise noted, temperatures are indicated in degrees Celsius.

Abbreviations used in Examples include:

N,N-dimethyl formamide: DMF,

N-methyl-2-pyrrolidone: NMP,

2-(4-carboxyphenyl)benzo[d]oxazole-5-carboxylic acid: ABO-100,

2-(4-carboxyphenyl)benzo[d]oxazole-5-carboxylic acid dichloride: ABO-001,

2-(3-carboxyphenyl)benzo[d]oxazole-5-carboxylic acid: ABO-300, and

N,N-dimethyl acetamide: DMAc.

The structures of synthesized compounds were identified by proton nuclear magnetic resonance (¹H-NMR) spectrum using a nuclear magnetic resonance spectrometer (“AVANCE400” (400 MHz) manufactured by Bruker Corporation). Chemical shifts (δ) are indicated in ppm.

### Synthesis Example 1

### Synthesis of 2-(4-carboxyphenyl)benzo[d]oxazole-5-carboxylic acid (ABO-100)

ABO-100 was synthesized in accordance with the following procedures (1) to (4).

### (1) Synthesis of methyl 3-amino-4-hydroxybenzoate hydrochloride

32.0 g (407 mmol) of acetyl chloride was added dropwise to 250 mL of methanol under ice-cooling. The mixture was stirred at room temperature for 30 minutes. 27.9 g (182 mmol) of 3-amino-4-hydroxybenzoic acid was then added and dissolved therein. After that, the mixture was heated and stirred at 80° C. for 4 hours. The mixture was cooled to room temperature, and then concentrated. The resulting residue was washed with 250 mL of ethyl acetate, and cooled to 0° C. Separation by filtration was performed to obtain a white solid. This solid was dried at 50° C. under reduced pressure overnight to obtain 30.7 g (151 mmol) of the title compound (yield: 83%).

1H-NMR (400 MHz, DMSO-d6) δ: 3.81 (3H, s), 7.14 (1H, d, J=8.52 Hz), 7.78 (1H, dd, J=8.52, 2.12 Hz), 7.92 (1H, d, J=2.12 Hz).

### (2) Synthesis of 2-hydroxy-5-methoxycarbonyl-N-(4-methoxycarbonyl-benzylidene)aniline

30.7 g (151 mmol) of methyl 3-amino-4-hydroxybenzoate hydrochloride was dissolved in 300 mL of methanol, and 15.6 g (154 mmol) of triethylamine was added dropwise. To the mixture, 24.8 g (151 mmol) of methyl terephthalaldehydate was added therein. The mixture was stirred at room temperature for 3 hours, concentrated, and dried to obtain a yellow solid. This solid was dried at 50° C. under reduced pressure overnight to obtain 47.2 g (151 mmol) of the title compound (yield: 100%).

1H-NMR (400 MHz, CDCl3) δ: 3.92 (3H, s), 3.97 (3H, s), 7.06 (1H, d, J=8.5 Hz), 7.59 (1H, br), 7.95 (1H, dd, J=8.52, 1.96 Hz), 8.00-8.02 (2H, m), 8.07 (1H, d, J=1.96 Hz), 8.16-8.18 (2H, m), 8.86 (1H, s).

### (3) Synthesis of Methyl 2-[4-(methoxycarbonyl)phenyl)benzo[d]oxazole-5-carboxylate

47.2 g (151 mmol) of 2-hydroxy-5-methoxycarbonyl-N-(4-methoxycarbonyl-benzylidene)aniline was dissolved in 500 mL of dichloromethane. The mixture was cooled to 0° C. 34.3 g (151 mmol) of 2,3-dichloro-5,6-dicyano-p-benzoquinone was added therein, and the mixture was stirred at 0° C. for 1 hour. The mixture was concentrated and dried to obtain a brown solid. The solid was washed with 1 L of 5% by weight potassium carbonate aqueous solution. Filtration was performed to obtain a brown solid. This solid was washed with 100 mL of toluene. Filtration was performed to obtain a light brown solid. This solid was dried at 50° C. under reduced pressure overnight to obtain 40.8 g (131 mmol) of the title compound (yield: 87%).

1H-NMR (400 MHz, CDCl3) δ: 3.92 (3H, s), 3.97 (3H, s), 7.65 (1H, d, J=9.12 Hz), 8.15 (1H, dd, J=8.56, 1.64 Hz), 8.20-8.22 (2H, m), 8.34-8.36 (2H, m), 8.50 (1H, m).

### (4) Synthesis of ABO-100

10.0 g (32.1 mmol) of methyl 2-[4-(methoxycarbonyl)phenyl)benzo[d]oxazole-5-carboxylate was dissolved in 100 mL of a solution of 1,4-dioxane/water at a ratio of 1/1. To the mixture, 3.37 g (80.3 mmol) of lithium hydroxide monohydrate was added therein. The mixture was heated and stirred at 50° C. for 1 hour. The mixture was cooled to room temperature, and then concentrated. The resulting residue was dissolved in 150 mL of water. The mixture was neutralized with concentrated hydrochloric acid to a pH of 3.0. The mixture was filtered to obtain a solid. The solid was washed with 100 mL of methanol to obtain a light brown solid. This solid was dried at 50° C. under reduced pressure overnight to obtain 8.18 g (28.9 mmol) of the title compound (yield: 90%).

1H-NMR (400 MHz, CDCl₃) δ: 7.94 (1H, d, J=8.96 Hz), 8.09 (1H, dd, J=8.52, 1.68 Hz), 8.16-8.18 (2H, m), 8.34-8.36 (3H, m).

### Synthesis Example 2

### Synthesis of ABO-001

3.00 g (10.6 mmol) of ABO-100 was suspended in 5 mL of thionyl chloride. To the mixture, 10 pt of DMF was added. The mixture was heated and stirred at 65° C. for 1 hour. The mixture was cooled to room temperature, and then concentrated. While the resulting residue was heated at 180° C., a pressure was reduced to 10 Torr, to cause sublimation purification. As a result, 1.23 g (3.8 mmol) of the title compound was obtained as a white solid (yield: 36%).

1H-NMR (400 MHz, CDCl₃) δ: 7.72 (1H, d, J=4.32 Hz), 8.23 (1H, dd, J=6.96, 0.70 Hz), 8.30 (2H, d, J=8.48 Hz), 8.42 (2H, d, J=8.48 Hz), 8.64 (1H, s).

### Synthesis Example 3

### Synthesis of 2-(3-carboxyphenyl)benzo[d]oxazole-5-carboxylic acid (ABO-300)

8.32 g (29.4 mmol) of the title compound having the following structure was obtained (total yield: 53.6%) by the same operation as in Synthesis Example 1 except that methyl isophthalaldehydate was used in place of methyl terephthalaldehydate.

1H-NMR (400 MHz, DMSO-d6) δ: 8.75 (1H, t, J=1.68 Hz), 8.46 (1H, dt, J=8.16, 1.24 Hz), 8.35 (1H, d, J=1.44 Hz), 8.20 (1H, dt, J=7.92, 1.24 Hz), 8.08 (1H, dd, J=8.52, 1.64 Hz), 7.94 (1H, d, J=8.60 Hz), 7.79 (1H, t, J=7.80 Hz).

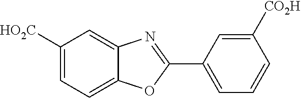 [SMILES: O=C(O)c1cccc(-c2nc3cc(C(=O)O)ccc3o2)c1]

### Example 1

### Synthesis of Polyamide Using ABO-100 and 1,5-Diaminopentane as Monomers

0.500 g (1.77 mmol) of ABO-100, 0.181 g (1.77 mmol) of 1,5-diaminopentane having the following structure, 0.967 mL (3.70 mmol) of triphenyl phosphite, and 0.25 g of lithium chloride were dissolved in 20 mL of NMP and 5 mL of pyridine. The mixture was stirred at 100° C. under an argon atmosphere for 18 hours. The reaction mixture was put in 10-fold volume of methanol. Filtration was performed to obtain a brown solid. This solid was washed with 100 mL of boiling methanol. Filtration was performed to obtain a brown solid. This solid was dried at 50° C. under reduced pressure overnight to obtain 0.44 g of the targeted polyamide compound (yield: 71%).

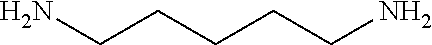

The obtained polyamide compound was subjected to evaluations (1) and (2) described below. The results are shown in Table 3.

### (1) Measurement of Extrapolated Glass Transition Onset Temperature T_{ig}, Middle Glass Transition Temperature T_{mg}, and Melting Point Tₘ

T_{ig}, T_{mg}, and Tₘ were measured by a differential scanning calorimeter (“DSC6200” manufactured by Seiko Instruments Inc.). The extrapolated glass transition onset temperature T_{ig} was determined from a temperature at the intersection of a straight line obtained by extending a base line on a side of lower temperature of a DSC thermogram in which a temperature was increased from 30° C. to 380° C. at a temperature increasing ratio of 10° C./min and a tangent line at a point in which the slope of a curve at stepwise change of glass transition is largest. The middle glass transition temperature T_{mg} (° C.) was determined from a temperature at an inflection of the DSC thermogram (a top of peak of differential curve). The melting point Tₘ (° C.) was determined from a top of endothermic peak of the DSC thermogram.

### (2) Measurement of 5% Mass Decrease Temperature T_{d}

T_{d} was measured by a thermogravimetric measurement device (“TG/DTA6200” manufactured by Seiko Instruments Inc.). The inside of a furnace was heated from room temperature to 550° C. at a temperature increasing rate of 10° C./min in a nitrogen atmosphere. From the resulting thermogravimetric curve, a temperature T_{d} (° C.) at which the amount was decreased by 5% was determined.

In the following Examples and Reference Examples, the same evaluation was performed. The results are also shown in Table 3.

### Example 2

### Synthesis of Polyamide Using ABO-100 and 1,6-Diaminohexane as Monomers

The same operation as in Example 1 was performed except that 1,6-diaminohexane having the following structure was used in place of 1,5-diaminopentane, to obtain 0.420 g of the targeted polyamide compound (light brown) (yield: 66%).

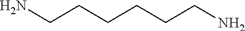

### Example 3

### Synthesis of Polyamide Using ABO-100 and 1,9-Diaminononane as Monomers

The same operation as in Example 1 was performed except that 1,9-diaminononane having the following structure was used in place of 1,5-diaminopentane, to obtain 0.63 g of the targeted polyamide compound (light brown) (yield: 88%).

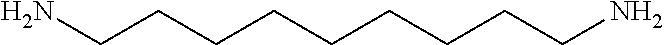 [SMILES: NCCCCCCCCCN]

### Example 4

### Synthesis of Polyamide Using ABO-100 and 4,4′-Methylenebis-(Cyclohexylamine) as Monomers

The same operation as in Example 1 was performed except that 4,4′-methylenebis(cyclohexylamine) having the following structure was used in place of 1,5-diaminopentane, to obtain 0.60 g of the targeted polyamide compound (light brown) (yield: 75%).

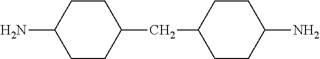 [SMILES: NC1CCC(CC2CCC(N)CC2)CC1]

### Example 5

### Synthesis of Polyamide Using ABO-100 and 1,2-Diaminopropane as Monomers

The same operation as in Example 1 was performed except that 1,2-diaminopropane having the following structure was used in place of 1,5-diaminopentane, to obtain 0.23 g of the targeted polyamide compound (light brown) (yield: 40%).

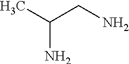

### Example 6

### Synthesis of Polyamide Using ABO-100 and 2,2′-Oxybis(Ethylamine) as Monomers

The same operation as in Example 1 was performed except that 2,2′-oxybis(ethylamine) having the following structure was used in place of 1,5-diaminopentane, to obtain 0.23 g of the targeted polyamide compound (light brown) (yield: 40%).

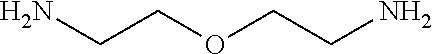

### Example 7

### Synthesis of Polyamide Using ABO-100 and p-Xylylenediamine as Monomers

The same operation as in Example 1 was performed except that p-xylylenediamine having the following structure was used in place of 1,5-diaminopentane, to obtain 0.65 g of the targeted polyamide compound (light brown) (yield: 96%).

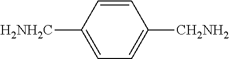

### Example 8

### Synthesis of Polyamide Using ABO-001 and 1,4-Bis(Aminopropyl)Piperazine as Monomers

0.125 g (0.626 mmol) of 1,4-bis(aminopropyl)piperazine having the following structure was dissolved in 10 mL of NMP. To the mixture, 0.200 g (0.626 mmol) of ABO-001 was added. The mixture was stirred at room temperature for 2 hours. The reaction mixture was put in 10-fold volume of methanol. Filtration was performed to obtain a light brown solid. This solid was washed with 100 mL of acetone. Filtration was performed to obtain a light brown solid. This solid was dried at 50° C. under reduced pressure overnight to obtain 0.42 g of the targeted polyamide compound (yield: 68%).

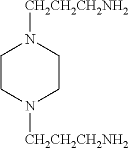

### Example 9

### Synthesis of Polyamide Using ABO-100 and 3,3′-Diaminodipropylamine as Monomers

The same operation as in Example 8 was performed except that 3,3′-diaminodipropylamine having the following structure was used in place of 1,4-bis(aminopropyl)piperazine, to obtain 0.19 g of the targeted polyamide compound (light brown) (yield: 80%).

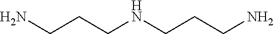

### Example 10

### Synthesis of Polyamide Using ABO-300 and 1,6-Diaminohexane as Monomers

The same operation as in Example 2 was performed except that ABO-300 was used in place of ABO-100, to obtain 0.48 g of the targeted polyamide compound (light brown) (yield: 75%).

### Example 11

### Synthesis of Polyamide Using ABO-300 and 1,9-Diaminononane as Monomers

The same operation as in Example 3 was performed except that ABO-300 was used in place of ABO-100, to obtain 0.50 g of the targeted polyamide compound (light brown) (yield: 70%).

### Reference Example 1

### Synthesis of Polyamide Using Terephthalic Acid and 1,5-Diaminopentane as Monomers

1.02 g (5.00 mmol) of terephthalic acid chloride was dissolved in 10 mL of DMAc and 1 mL of pyridine. To the mixture, 0.511 g (5.00 mmol) of 1,5-diaminopentane dissolved in 5 mL of DMAc was added therein. The mixture was stirred at room temperature for 1 hour. The reaction mixture was put in 10-fold volume of methanol. Filtration was performed to obtain a light brown solid. This solid was washed with 100 mL of methanol. Filtration was performed to obtain a brown solid. This solid was dried at 50° C. under reduced pressure overnight to obtain 1.16 g of a polyamide compound (yield: 86%).

### Reference Example 2

### Synthesis of Polyamide Using Terephthalic Acid and 1,6-Diaminohexane as Monomers

The same operation as in Reference Example 1 was performed except that 1,6-diaminohexane was used in place of 1,5-diaminopentane, to obtain 0.90 g of the polyamide compound (white) (yield: 64%).

### Reference Example 3

### Synthesis of Polyamide Using Terephthalic Acid and 1,9-Diaminononane as Monomers

The same operation as in Reference Example 1 was performed except that 1,9-diaminononane was used in place of 1,5-diaminopentane, to obtain 1.46 g of the polyamide compound (light brown) (yield: 90%).

TABLE 3

| | | Dicarboxylic | | Tig | Tmg | Tm | Td |
|---|---|---|---|---|---|---|---|
| | | acid monomer | Diamine monomer | (° C.) | (° C.) | (° C.) | (° C.) |
| Example | 1 | ABO-100 | 1,5-diaminopentane | 233 | 258 | 362 | 398 |
| | 2 | ABO-100 | 1,6-diaminohexane | 250 | 271 | 368 | 392 |
| | 3 | ABO-100 | 1,9-diaminononane | 232 | 255 | 326 | 367 |
| | 4 | ABO-100 | 4,4'-methylenebis | 119 | 120 | 275 | 305 |
| | | | (cyclohexylamine) | | | | |
| | 5 | ABO-100 | 1,2-diaminopropane | 121 | 128 | N.D. | 318 |
| | 6 | ABO-100 | 2,2'-oxybis(ethylamine) | 145 | 154 | 290 | 326 |
| | 7 | ABO-100 | p-xylylenediamine | 208 | 220 | 349 | 375 |
| | 8 | ABO-001 | 1,4-bis(aminopropyl) | 162 | 175 | N.D. | 322 |
| | | | piperazine | | | | |
| | 9 | ABO-001 | 3,3'-diamino | 177 | 199 | N.D. | 340 |
| | | | dipropylamine | | | | |
| | 10 | ABO-300 | 1,6- diaminohexane | 108 | 111 | 281 | 372 |
| | 11 | ABO-300 | 1,9-diaminononane | 97 | 102 | 237, 248 | 391 |
| Reference | 1 | terephthalic acid | 1,5-diaminopentane | 165 | 177 | 333 | 387 |
| Example | 2 | terephthalic acid | 1,6-diaminohexane | 126 | 133 | 370 | 410 |
| | 3 | terephthalic acid | 1,9-diaminononane | 108 | 115 | 371 | 405 |

Where a numerical limit or range is stated herein, the endpoints are included. Also, all values and subranges within a numerical limit or range are specifically included as if explicitly written out.

As used herein the words “a” and “an” and the like carry the meaning of “one or more.”

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. A polyamide compound, which is obtained by reacting:
(1) a compound represented by formula (1): 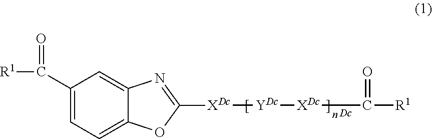
wherein:
R¹ is a hydroxy group, a halogen atom, an alkoxy group, a cycloalkyloxy group, an aryloxy group, —OM, or —O—Si(R²)₃, wherein M is a metal atom, and R² is an alkyl group;
X^{Dc} is a divalent aromatic group optionally having a substituent, a divalent aliphatic hydrocarbon group optionally having a substituent, or a divalent non-aromatic heterocyclic group optionally having a substituent;
Y^{Dc} is —O—, —N═N—, a carbonyl group, an alkenylene group optionally having a substituent, or a single bond; and
n^{Dc} is an integer of 0 to 2;
wherein:
the two R¹ groups may be the same or different from each other;
when there are a plurality of X^{Dc} groups, they may be the same or different from each other; and
when there are a plurality of X^{Dc} groups, they may be the same or different from each other,
with a compound represented by formula (2): 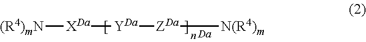
wherein:
m is 1 or 2;
when m is 1, R⁴ is ═C═O, and when m is 2, R⁴ is a hydrogen atom, an acyl group, or —Si(R⁵)₃, wherein R⁵ is an alkyl group;
X^{Da} represents a divalent aliphatic hydrocarbon group optionally having a substituent;
Y^{Da} is an imino group optionally having a substituent, a divalent aromatic group optionally having a substituent, a divalent non-aromatic heterocyclic group optionally having a substituent, an oxyalkylene group optionally having a substituent, —S—, an alkylene group optionally having a substituent, or a cycloalkylene group optionally having a substituent;
Z^{Da} is a divalent aliphatic hydrocarbon group optionally having a substituent or a single bond; and
n^{Da} is an integer of 0 to 5;
wherein:
each of the plurality of R⁴ groups may be the same or different from each other;
when there are a plurality of Y^{Da} groups, they may be the same or different from each other; and
when there are a plurality of Z^{Da} groups, they may be the same or different from each other.

2. The polyamide compound according to claim 1, wherein X^{Dc} is a phenylene group optionally having a substituent, a naphthylene group optionally having a substituent, an anthracenylene group optionally having a substituent, a frandiyl group optionally having a substituent, a pyridinediyl group optionally having a substituent, a thiophenediyl group optionally having a substituent, a quinolinediyl group optionally having a substituent, an alkylene group optionally having a substituent, a cycloalkylene group optionally having a substituent, an alkenylene group optionally having a substituent, a cycloalkenylene group optionally having a substituent, an alkynylene group optionally having a substituent, or a divalent non-aromatic heterocyclic group having an oxygen atom as a heteroatom constituting the heterocyclic ring and optionally having a substituent.

3. The polyamide compound according to claim 1, wherein X^{Da} is an alkylene group optionally having a substituent or a cycloalkylene group optionally having a substituent.

4. The polyamide compound according to claim 1, wherein Z^{Da} is an alkylene group optionally having a substituent, a cycloalkylene group optionally having a substituent, or a single bond.

5. The polyamide compound according to claim 1, wherein n^{Dc} is 0, and X^{Dc} is a phenylene group optionally having a substituent.

6. The polyamide compound according to claim 1, wherein:
i) n^{Da} is 0, and X^{Da} is an alkylene group having 1 to 15 carbon atoms, and optionally having a substituent, or a cycloalkylene group having 3 to 10 carbon atoms and optionally having a substituent; or
ii) n^{Da} is 1 or 2, X^{Da} is an alkylene group, having 1 to 6 carbon atoms, and optionally having a substituent, or a cycloalkylene group, having 3 to 10 carbon atoms, and optionally having a substituent, Y^{Da} is an imino group optionally having a substituent, an oxyalkylene group, having 1 to 6 carbon atoms, and optionally having a substituent, a divalent non-aromatic heterocyclic group, having a nitrogen atom as a heteroatom constituting the heterocyclic ring and 2 to 5 carbon atoms, and optionally having a substituent, or a phenylene group optionally having a substituent, and Z^{Da} is an alkylene group, having 1 to 3 carbon atoms, and optionally having a substituent, a cycloalkylene group, having 3 to 10 carbon atoms, and optionally having a substituent, or a single bond.

7. The polyamide compound according to claim 1, wherein said substituent is selected from the group consisting of a halogen atom, an alkyl group, an aryl group, an alkylidene group, a hydroxy group, an amino group, and an oxo group.

8. The polyamide compound according to claim 1, wherein said compound represented by formula (2) is one or more compounds represented by formulae (2-1) to (2-36):

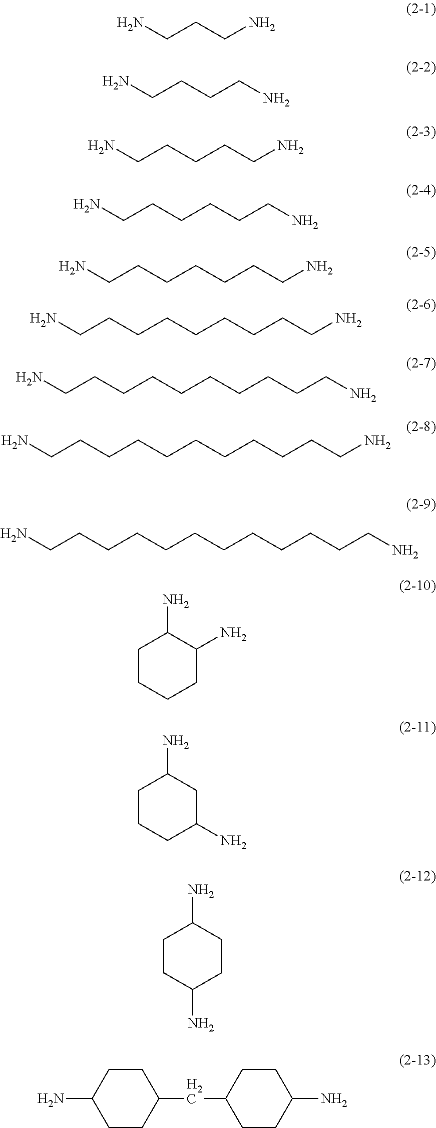

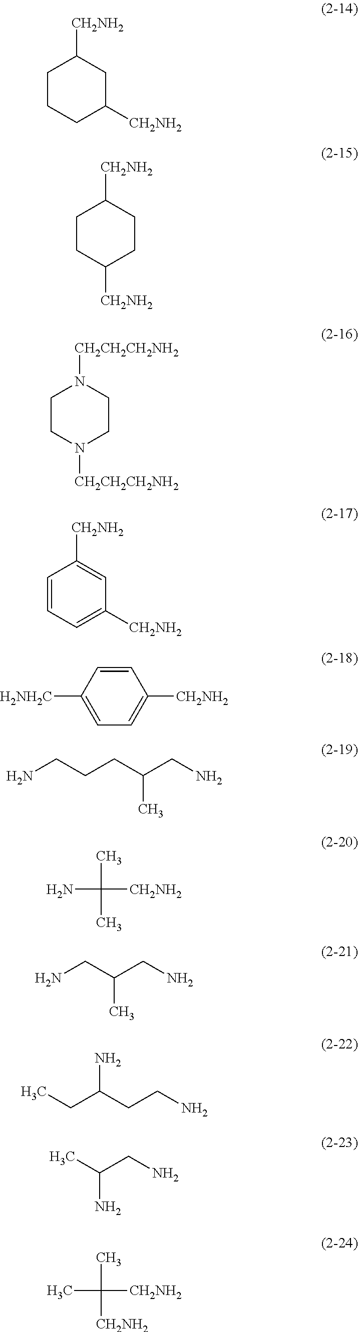

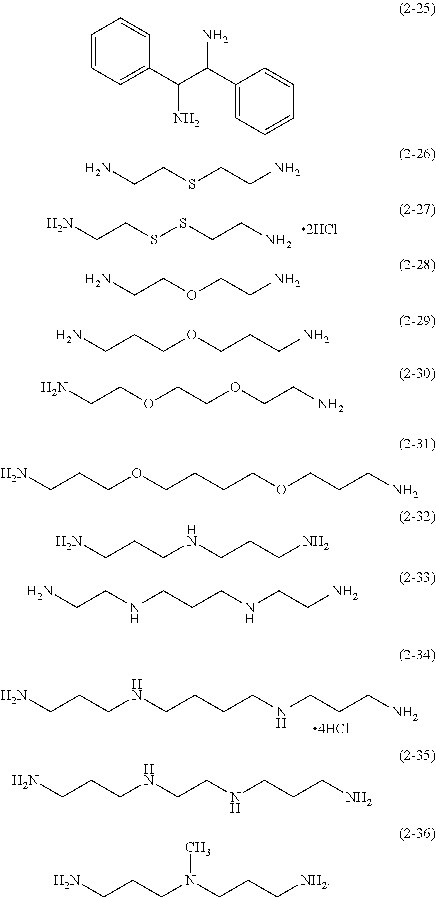

9. The polyamide compound according to claim 8, wherein said compound represented by formula (2) is a compound represented by formula (2-3), (2-4), (2-6), (2-13), (2-16), (2-18), (2-23), (2-28), or (2-32).

10. The polyamide compound according to claim 1, which is obtained by a reaction of a compound represented by formula (1), a compound represented by formula (2), and one or more members selected from the group consisting of an aromatic dicarboxylic acid, a salt thereof, an ester thereof, and a halide thereof.

11. The polyamide compound according to claim 1, which is obtained by a reacting said compound represented by formula (1) with said compound represented by formula (2) in a molar ratio (the compound represented by the formula (1))/(the compound represented by the formula (2)) of 10/1 to 1/10.

12. The polyamide compound according to claim 1, wherein said reacting is conducted at a temperature of −10° C. to 200° C.

13. A polyamide compound, containing one or more structural units represented by formulae (i) to (iv): 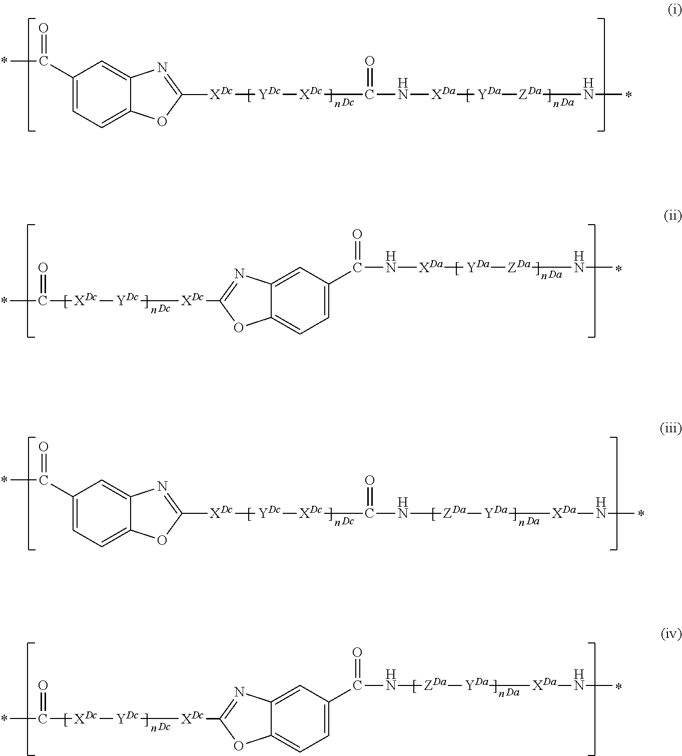
wherein:
X^{Dc} is a divalent aromatic group optionally having a substituent, a divalent aliphatic hydrocarbon group optionally having a substituent, or a divalent non-aromatic heterocyclic group optionally having a substituent;
Y^{Dc} is —O—, —N═N—, a carbonyl group, an alkenylene group optionally having a substituent, or a single bond;
n^{Dc} is an integer of 0 to 2;
X^{Da} is a divalent aliphatic hydrocarbon group optionally having a substituent;
Y^{Da} is an imino group optionally having a substituent, a divalent aromatic group optionally having a substituent, a divalent non-aromatic heterocyclic group optionally having a substituent, an oxyalkylene group optionally having a substituent, —S—, an alkylene group optionally having a substituent, or a cycloalkylene group optionally having a substituent;
Z^{Da} is a divalent aliphatic hydrocarbon group optionally having a substituent or a single bond; and
n^{Da} is an integer of 0 to 5; and
* represents the connection point to the rest of the compound;
wherein:
when there are a plurality of X^{Dc} groups, they may be the same or different from each other;
when there are a plurality of Y^{Dc} groups, they may be the same or different from each other;
when there are a plurality of Y^{Da} groups, they may be the same or different from each other; and
when there are a plurality of Z^{Da} groups, they may be the same as or different from each other.

14. The polyamide compound according to claim 13, which exhibits a middle glass transition point (T_{mg}) of 100° C. or higher and 400° C. or lower.

15. The polyamide compound according to claim 13, which exhibits a melting point (Tₘ) of 230° C. or higher and 500° C. or lower.

16. The polyamide compound according to claim 13, which exhibits a 5% mass decrease temperature (T_{d}) of 250° C. or higher and 500° C. or lower.

17. A method of producing a polyamide compound, comprising reacting
(1) a compound represented by formula (1): 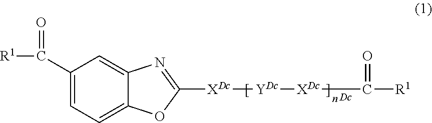
wherein:
R¹ is a hydroxy group, a halogen atom, an alkoxy group, a cycloalkyloxy group, an aryloxy group, —OM, or —O—Si(R²)₃, wherein M is a metal atom, and R² is an alkyl group;
X^{Dc} is a divalent aromatic group optionally having a substituent, a divalent aliphatic hydrocarbon group optionally having a substituent, or a divalent non-aromatic heterocyclic group optionally having a substituent;
Y^{Dc} is —O—, —N═N—, a carbonyl group, an alkenylene group optionally having a substituent, or a single bond; and
n^{Dc} is an integer of 0 to 2;
wherein:
the two R¹ groups may be the same or different from each other;
when there are a plurality of X^{Dc} groups, they may be the same or different from each other; and
when there are a plurality of Y^{Dc} groups, they may be the same or different from each other, with
(2) a compound represented by formula (2): 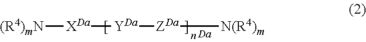
wherein:
m is 1 or 2;
when m is 1, R⁴ is ═C═O, and when m is 2, R⁴ is a hydrogen atom, an acyl group, or —Si(R⁵)₃, wherein R⁵ is an alkyl group;
X^{Da} is a divalent aliphatic hydrocarbon group optionally having a substituent;
Y^{Da} is an imino group optionally having a substituent, a divalent aromatic group optionally having a substituent, a divalent non-aromatic heterocyclic group optionally having a substituent, an oxyalkylene group optionally having a substituent, —S—, an alkylene group optionally having a substituent, or a cycloalkylene group optionally having a substituent;
Z^{Da} is a divalent aliphatic hydrocarbon group optionally having a substituent or a single bond; and
n^{Da} is an integer of 0 to 5;
wherein:
each of the plurality of R⁴ groups may be the same or different from each other;
when there are a plurality of Y^{Da} groups, they may be the same or different from each other; and
when there are a plurality of Z^{Da} groups, they may be the same as or different from each other,
at a molar ratio of (the compound represented by formula (1))/(the compound represented by formula (2)) of 10/1 to 1/10.
